(19) United States
(12) Patent Application Publication
(10) Pub. No.: US 2009/0169021 A1
(43) Pub. Date: Jul. 2, 2009

(54) Content distribution system, information processing method and terminal apparatus in content distribution system, and recording medium on which is recorded program thereof

(75) Inventor: Kentaro Ushiyama, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/379,532

(22) Filed: Feb. 24, 2009

Related U.S. Application Data
(63) Continuation-in-part of application No. PCT/JP2007/064398, filed on Jul. 23, 2007.

(30) Foreign Application Priority Data
Aug. 31, 2006 (JP) 2006-237056

(51) Int. Cl. G06F 15/16; H04L 9/08

(52) U.S. Cl. 380/279; 709/218

(57) ABSTRACT

In a terminal apparatus configuring the content distribution system, when a user's content data acquisition request operation is detected, content data corresponding to the acquisition request operation are acquired, via the network, from another terminal apparatus, and stored. Subsequently, when there is a request from another terminal apparatus for a transmission of the stored content data, the content data corresponding to the transmission request are transmitted to the another terminal apparatus. Meanwhile, a reproduction of the content data being restricted when a reservation period of the acquired content data is not finished, the reproduction of the content data is possible when the reservation period is finished.

### CROSS-REFERENCE TO RELATED APPLICATION(S)

The present application is a Continuation-in-Part of International Application PCT/JP2007/064398 filed on Jul. 23, 2007, which claims the benefits of Japanese Patent Application No. 2006-237056 filed on Aug. 31, 2006.

### BACKGROUND

1. Field

The present invention relates to a technical field of a content distribution via a network, and more particularly, relates to a content distribution system, including a plurality of terminal apparatus disposed dispersed in a network, which carries out a transmission and reception of content data among the terminal apparatus by means of a P2P, an information processing method and terminal apparatus in the content distribution system, and a recording medium on which is recorded a program thereof.

2. Description of the Related Art

In recent years, a so-called content distribution system, which distributes content data (hereafter, also referred to as “content”) such as music, a movie, or a talk program, via a network such as the Internet, has been an active area of research.

In Japanese Unexamined Patent Publication No. 2006-197400, in a peer-to-peer (P2P) type of content distribution system, each terminal apparatus becomes a content distribution server which holds content data, and each terminal apparatus also becomes a content distribution request client.

As this kind of content distribution system, one being known in which a terminal apparatus which, as a content distribution request client, has acquired content data from a terminal apparatus functioning as a content distribution server functions as a content distribution server, terminal apparatus which are to hold the content data increase in accordance with an increase of distribution requests for the content data.

Consequently, as terminal apparatus which can distribute the content data increase in accordance with a popularity of the content, it is possible to avoid a concentration of accesses to a specific terminal apparatus.

### SUMMARY

However, with the heretofore described content distribution system, by content data being introduced to the terminal apparatus in the system, and a transmission and reception of the disclosed content data being carried out among the terminal apparatus, the terminal apparatus which can distribute the content data are increased sequentially.

Conversely, it is common that popular content becomes less popular with the passing of time from a disclosure time. That is, it is often the case that the content data attain a condition of greatest popularity when they are disclosed in the content distribution system.

However, as there are few terminal apparatus holding the content data at the disclosure time in the content distribution system, there is a disadvantage in that accesses concentrate on a specific terminal apparatus holding the content data, and it is difficult to acquire desired content, without stress and at a high quality, and view it in the terminal apparatus of a plurality of users desiring a distribution of the content data.

In view of the heretofore described disadvantage, it is desirable to provide a content distribution system, and an information processing method and the like thereof, which can avoid accesses concentrating on a specific terminal apparatus when content data are visibly or audibly disclosed, in a P2P type of content distribution system which has a plurality of terminal apparatus disposed dispersed in a network.

According to one aspect of the invention, a content distribution system includes a plurality of terminal apparatus disposed dispersed in a network, and carries out a transmission and reception of content data among the terminal apparatus. The terminal apparatus includes: a content data acquisition request detection module which detects a content data acquisition request operation by a user; a content data acquisition module which, when the acquisition request operation is detected by the content data acquisition request detection module, acquires the content data corresponding to the acquisition request operation from another terminal apparatus, via the network; a content data storage module which stores the content data acquired by the content data acquisition module; a content data transmission module which, when there has been a request from another terminal apparatus for a transmission of the content data stored in the content data storage module, transmits content data corresponding to the transmission request to another terminal apparatus; a disclosure condition acquisition module which acquires disclosure condition information of the content data acquired by the content data acquisition module; a disclosure condition determination module which, based on the disclosure condition information acquired by the disclosure condition acquisition module, determines whether or not the content data acquired by the content data acquisition module meet a disclosure condition thereof, and a content data reproduction module which carries out a reproduction of content data determined by the disclosure condition determination module to meet the disclosure condition.

### BRIEF DESCRIPTION OF THE DRAWINGS

FIG. 1 is a diagram showing one example of a connection aspect of each terminal apparatus in a content distribution system according to an embodiment;

FIG. 2 is an illustration of an ID space;

FIGS. 3A and 3B are diagrams showing one example of an aspect of a routing table compiled by a DHT;

FIG. 4 is one example of a routing table of the terminal apparatus according to the embodiment;

FIG. 5 is a diagram showing one example of an aspect of a terminal apparatus which is a holder of content data being searched for with the DHT;

FIGS. 6A and 6B are diagrams of an aspect of a content holding terminal apparatus registration message being forwarded, represented in a spanning tree form;

FIG. 7 is one example of an index table of the terminal apparatus according to the embodiment;

FIGS. 8A and 8B are diagrams for illustrating a content holding terminal apparatus disposition method;

FIG. 9 is a diagram for illustrating the content holding terminal apparatus disposition method;

FIG. 10 is a diagram for illustrating the content holding terminal apparatus disposition method;

FIG. 11 is a diagram for illustrating the content holding terminal apparatus disposition method;

FIG. 12 is a diagram showing an example of an outline configuration of the terminal apparatus according to the embodiment;

FIG. 13 is a diagram showing an example of an outline configuration of a content server apparatus according to the embodiment;

FIG. 14 is a diagram showing an example of an outline configuration of a decryption key management apparatus according to the embodiment;

FIG. 15 is a flowchart showing a main process in the terminal apparatus;

FIG. 16 is a flowchart showing a content acquisition process in the terminal apparatus;

FIG. 17 is a flowchart showing a main process in the content server apparatus; and

FIG. 18 is a flowchart showing a main process in the decryption key management apparatus.

### DETAILED DESCRIPTION

Hereafter, a description will be given, based on the drawings, of a preferred embodiment of the invention. The embodiment to be described hereafter is an embodiment of a case in which the invention is applied to a pastry type or tapestry type of content distribution system, which has content data such as music data or image data as information to be distributed.

1. Configuration and the Like of Content Distribution System S

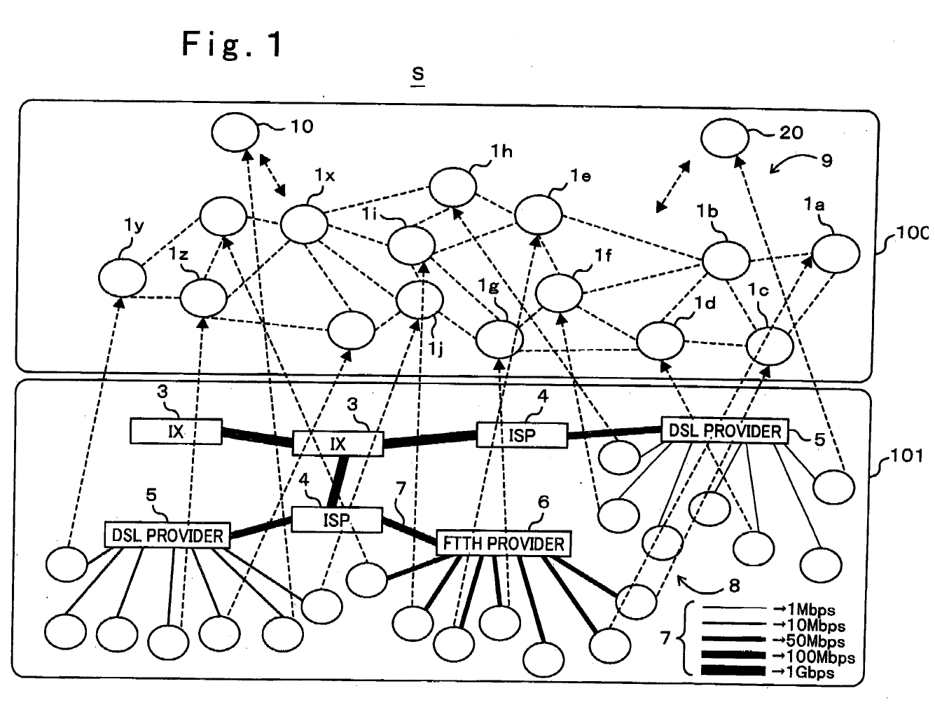

Firstly, a description will be given, referring to FIG. 1, of an outline configuration and the like of a content distribution system S as an information distribution system. FIG. 1 is a diagram showing an example of a connection aspect of each terminal apparatus in the content distribution system S according to the embodiment. The content distribution system, being configured of a plurality of terminal apparatus disposed distributed on a network, carries out a transmission and reception of content data among the terminal apparatus.

As shown within a lower frame 101 of FIG. 1, a network (a network in the actual world) 8, such as the Internet, is constructed of an IX (Internet eXchange) 3, an ISP (Internet Service Provider) 4, a DSL (Digital Subscriber Line) provider (a device thereof) 5, an FTTH (Fiber To The Home) provider (a device thereof) 6, and a communication line (for example, a telephone line, an optical cable, or the like) 7.

As shown within an upper frame 100 of FIG. 1, the content distribution system S, being configured including a plurality of terminal apparatus 1a, 1b, 1c . . . 1x, 1y, 1z . . . mutually connected via the network 8, is a peer-to-peer (P2P) type of network system. A unique manufacturing number (for example, a MAC address) and IP (Internet Protocol) address are allotted, as information indicating a terminal apparatus, to each terminal apparatus 1a, 1b, 1c . . . 1x, 1y, 1z . . . . The manufacturing number and IP address are not duplicated among the plurality of terminal apparatus. Also, in the following description, in a case of indicating any one terminal apparatus among the terminal apparatus 1a, 1b, 1c . . . 1x, 1y, 1z . . . , it may be referred to as the terminal apparatus 1, for the sake of convenience.

1.1. DHT Outline

Hereafter, a description will be given of an algorithm using a distributed hash table (hereafter called a “DHT”) according to the embodiment.

In the heretofore described content distribution system S, when the terminal apparatus 1 exchange information with each other, they have to know each other's IP address, which is location information.

For example, in a system in which content are shared, although each terminal apparatus 1 participating in the network 8 knows the IP addresses of all other terminal apparatus 1 participating in the network 8 by a simple method, in the event that a number of terminal apparatus rises to several tens of thousands, or several hundreds of thousands, it is not realistic to attempt to remember the IP addresses of all the terminal apparatus 1. Also, in the event that power of an optional terminal apparatus 1 is frequently turned on or off, the IP address of the optional terminal apparatus 1 stored in each terminal apparatus 1 being updated frequently, operation becomes difficult.

Therein, only the IP addresses of a minimally necessary portion of terminal apparatus 1, among all the terminal apparatus 1 participating in the network 8, being stored in one terminal apparatus 1, regarding terminal apparatus 1 of which the IP addresses are not stored, a system is being considered whereby content is delivered by forwarding information amongst the terminal apparatus 1.

As one example of this kind of system, a kind of overlay network 9 shown within the upper frame 100 of FIG. 1 is constructed by the algorithm using the DHT. That is, the overlay network 9 refers to a network configuring a virtual link formed using the already existing network 8.

In the embodiment, with the overlay network 9 constructed by the algorithm using the DHT as a precondition, terminal apparatus 1 disposed on the overlay network 9 are referred to as terminal apparatus 1 participating in the content distribution system S (in other words, participating in the overlay network 9).

A unique number is given to each terminal apparatus 1 as terminal ID, which is an identification number of each terminal apparatus 1 participating in the content distribution system S. It is necessary to give this number a number of bits equivalent to a maximum operational number of terminal apparatus which can be accommodated. For example, in a case of a number of 128 bits, it is possible to operate 2¹²⁸≈340×10³⁶ terminal apparatus.

More specifically, the terminal ID's of each terminal apparatus 1, being hash values obtained by hashing a value unique to each terminal apparatus 1, such as the IP address or manufacturing number of each terminal apparatus 1, with a common hash function (a hash algorithm), are disposed, distributed without bias, in one ID space.

As long as the relevant IP address or manufacturing number differs, a probability of terminal ID calculated by hashing with the common hash function in this way having the same value is extremely low. As the hash function is public knowledge, a detailed description will be omitted. Also, in the embodiment, a value of the IP address (a global IP address) hashed with the common hash function will be taken as the terminal ID.

Also, in the plurality of terminal apparatus 1 participating in the content distribution system S, although content data (for example, music data, movie data, document data, or the like), as common information distributed from one terminal apparatus 1 to other terminal apparatus 1, are stored distributed, an identification number (hereafter called “content ID”), unique to each item of content data, is given to the content data too.

Then, the content ID is made the same length as the terminal ID (for example, 128 bits, or the like), a content name (a content title) is hashed with the common hash function when the terminal ID is acquired (that is, it is disposed in the same ID space as the hash value of the terminal apparatus 1 IP address), and a terminal apparatus 1 having a terminal ID nearest to the hash value (for example, of which the most leading digits match) holds, as a root terminal apparatus to be described hereafter, information linking to a terminal apparatus 1 which holds content data (hereafter called a “content holding terminal apparatus”), that is, the IP address of the content holding terminal apparatus.

It can be supposed that, even in a case of differing content data, it may happen that keywords (for example, content names) are identical, but in this case, in order to avoid this, as the hash value is the same, it is sufficient to make the hashed keyword a combination of, for example, content outline information (a synopsis), a content name, and copyright information (for example, a performer's name, a director's name, a writer's name, a singer's name, a composer's name, a lyricist's name, and the like).

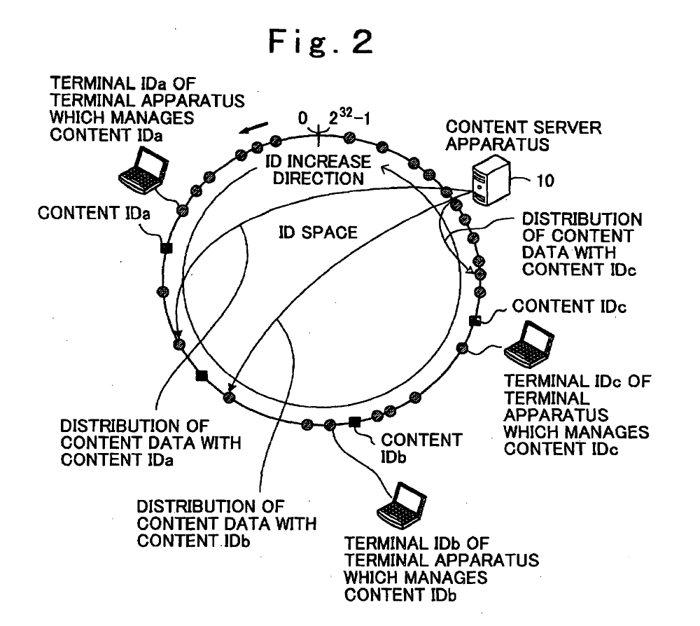

In this way, as the terminal ID and content ID, given respectively to each terminal apparatus 1 and each item of content data, are generated by the common hash function, it is possible to think of them existing scattered, with no particular bias, on one ring-shaped ID space, as shown in FIG. 2. The figure illustrates the terminal ID and content ID given at 32 bits. In the figure, round marks indicate the terminal ID, and squares the content ID, and the ID increase in a counter-clockwise direction.

Next, which item of content data is managed by which terminal apparatus 1 is decided under a certain rule. In the embodiment, the rule is such that “a terminal apparatus 1 managing content data which have a certain content ID is a terminal apparatus 1 which has a terminal ID near the content ID”.

Herein, a definition of “near” is that, without exceeding the content ID, a difference between the content ID and the terminal ID is the smallest, although in practice another definition is also acceptable, as long as it is consistent when allotting a management of the content data to the terminal apparatus 1.

In the example shown in FIG. 2, based on the definition, a content IDa is managed by a terminal apparatus 1 having a terminal ID near the content IDa (hereafter called a “terminal IDa”), a content IDb is managed by a terminal apparatus 1 having a terminal ID near the content IDb (hereafter called a “terminal IDb”), and a content IDc is managed by a terminal apparatus 1 having a terminal ID near the content IDc (hereafter called a “terminal IDc”).

Herein, “managed” means, not that the terminal apparatus 1 is holding the content data, but that “it knows which terminal apparatus 1 the content data are being held in”. That is, in FIG. 2, the terminal apparatus 1 which has the terminal IDa knows in which of the terminal apparatus 1 the content data having the content IDa are being held, and the terminal apparatus 1 which has the terminal IDb, and the terminal apparatus 1 which has the terminal IDc, also know, in the same way, in which of the terminal apparatus 1 the content data having the content IDb, and the content data having the content IDc, respectively are being held.

In this way, the terminal apparatus 1 which knows in which of the terminal apparatus 1 certain content data are being held is called the root terminal apparatus of those content data. That is, the terminal apparatus 1 which has the terminal IDa is the root terminal apparatus of the content data having the content IDa, the terminal apparatus 1 which has the terminal IDb is the root terminal apparatus of the content data having the content IDb, and the terminal apparatus 1 which has the terminal IDc is the root terminal apparatus of the content data having the content IDc.

Also, as shown in FIGS. 1 and 2, a content server apparatus 10, having a function of introducing content data into the content distribution system S, that is, a function of distributing content data, in order to make a terminal apparatus 1 within the content distribution system S a content holding terminal apparatus, to the terminal apparatus 1, and a function of generating a catalog list, and providing it to the terminal apparatus 1, and a decoding key management apparatus 20, which transmits a decoding key for decoding content data in response to a request from the terminal apparatus 1, are provided in the content distribution system S.

1.2. Routing Table Compilation

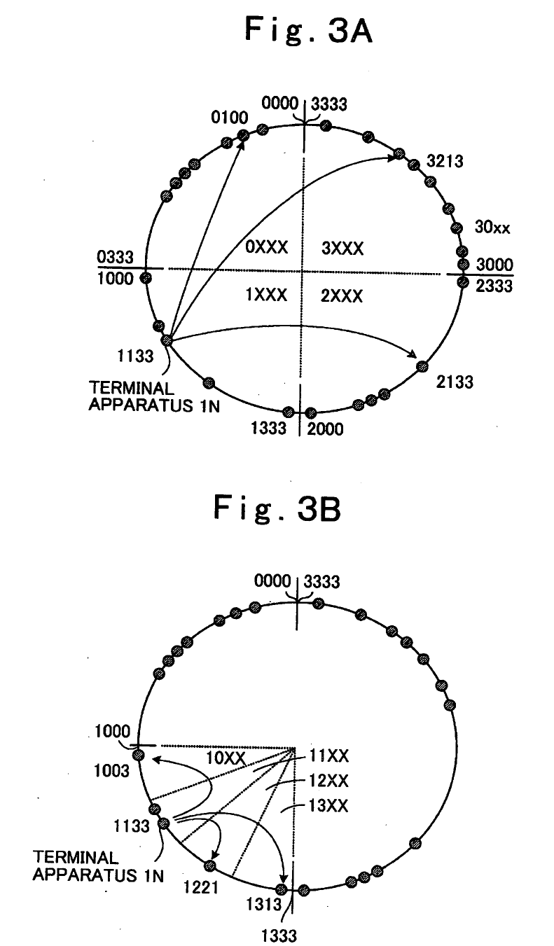

Herein, referring to FIGS. 3A and 3B, a description will be given of one example of a method of compiling a routing table used in the DHT. FIGS. 3A and 3B are diagrams showing one example of an aspect of a routing table compiled by the DHT.

Firstly, as shown in FIG. 3A, an ID space is divided into a number of areas. Although, in practice, a 16-division scale is often used, four divisions will be used here, in order to simplify the description, and ID's will be expressed in bit lengths of eight bits in base four. Then, taking terminal ID of a terminal apparatus 1N to be “1133”, a description will be given of an example of making a routing table of the terminal apparatus 1N.

Level 1 Routing

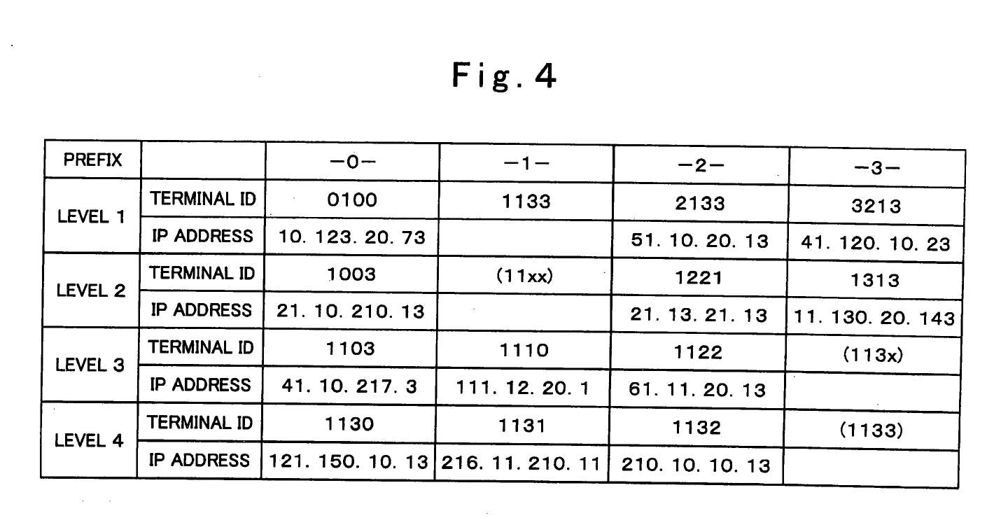

Firstly, in a case of dividing the ID space into four, it is divided into four areas, “0XXX”, “1XXX”, “2XXX” and “3XXX” (X is a positive integer between 0 and 3 inclusive, the same applying hereafter), of which first digits differ when each area is expressed in base four. The terminal apparatus 1N, the terminal ID of the terminal apparatus 1N itself being “1133”, exists in the area “1XXX” in a bottom left in FIG. 3A. Then, the terminal apparatus 1N, from information and the like transmitted from a terminal apparatus 1 which has received a participation request, selects a terminal apparatus 1 existing in an area (that is, the area “0XXX”, the area “2XXX” or the area “3XXX”) other than the area in which it exists itself (that is, the area “1XXX”), and stores terminal ID and an IP address of the terminal apparatus in a level 1 table. FIG. 4 is one example of the level 1 table. In the table, “0100” as terminal ID of the area “0XXX”, “2133” as terminal ID of the area “2XXX”, and “3213” as terminal ID of the area “3XXX”, each indicate a selected condition. As a second column of the level 1 shows the terminal apparatus 1N itself, it is not necessary to store an IP address.

Level 2 Routing

Next, as shown in FIG. 3B, of the four areas formed by the heretofore described routing, the terminal apparatus 1N further divides the area in which it exists itself (“1XXX”) in four, making it into four new areas, “10XX”, “11XX”, “12XX” and “13XX”. Then, in the same way as heretofore described, the terminal apparatus 1N appropriately selects a terminal apparatus 1 existing in an area other than the area in which it exists itself (“11XX”), and stores terminal ID and an IP address of the terminal apparatus 1 in a level 2 table. FIG. 4 is one example of the level 2 table. In the table, “1003” as terminal ID of the area “10XX”, “1221” as terminal ID of the area “12XX”, and “1313” as terminal ID of the area “13XX”, each indicates a selected condition. A second column of the level 2 being the area “11XX” in which the terminal apparatus 1N exists, an IP address is not stored, because it is tabulated in a level 3, to be described hereafter. Also, in the event that no terminal apparatus 1 exists in the heretofore described areas, terminal ID and IP address sections are empty.

Level 3 Routing

Furthermore, of the four areas formed by the heretofore described routing, the terminal apparatus 1N further divides the area in which it exists itself (“11XX”) in four, making it into four new areas, “110X”, “111X”, “112X” and “113X”. Then, in the same way as heretofore described, the terminal apparatus 1N appropriately selects a terminal apparatus 1 existing in an area other than the area in which it exists itself (“113X”), and stores terminal ID and an IP address of the terminal apparatus 1 in a level 3 table. FIG. 4 is one example of the level 3 table. A fourth column of the level 3 being the area in which the terminal apparatus 1N exists, an IP address is not stored, because it is tabulated in a level 4, to be described hereafter. Also, in the event that no terminal apparatus 1 exists in the heretofore described areas, the terminal ID and IP address sections are empty.

In this way, by compiling the routing table, as shown in FIG. 4, in the same way as far as the level 4, it is possible to encompass all the eight bit ID. Each time the level rises, empty spaces in the table stand out more.

All the terminal apparatus 1 individually compile and possess respective routing tables compiled in accordance with the heretofore described method. In this way, each terminal apparatus 1 has a routing table to which are correlated terminal ID and IP addresses, which are identification information of one portion of terminal apparatus 1 among the plurality of terminal apparatus 1 in the content distribution system S.

1.3. Content Data Search Method

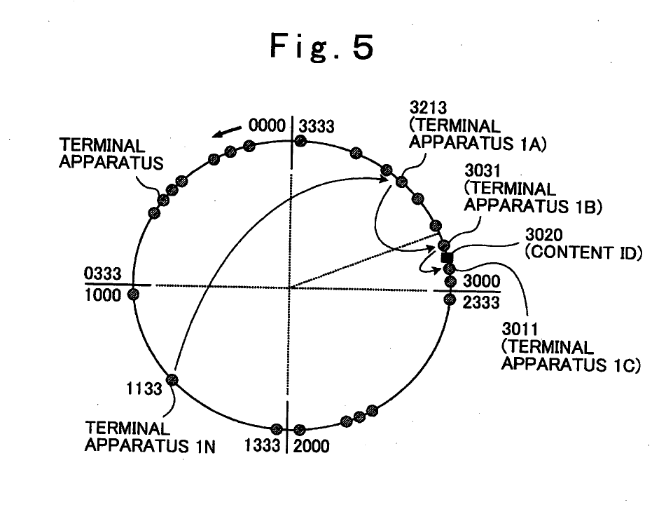

Next, referring to FIG. 5, a description will be given of one example of a method of searching for a terminal apparatus 1 which is holding content data. FIG. 5 is a diagram showing one example of an aspect of a terminal apparatus 1 which is holding content data being searched for by the DHT.

Herein, a description will be given of a procedure when the terminal apparatus 1N with the terminal ID “1133” searches for content data which have a content ID “3020”. Hereafter, a terminal apparatus 1 which searches for content data, and requests a transmission of the content data, in this way will be called a request terminal apparatus.

The request terminal apparatus 1N, making the content ID “3020” destination identification information, refers to the routing table which it is holding itself, and transmits a request for a transmission (hereafter called a “search message”) of content holding terminal apparatus identification information. Supposing that the request terminal apparatus 1N has a routing table of the same values as the example of FIG. 4, the content ID “3020” being in the area “3XXX”, it transmits the search message to, among terminal apparatus 1 belonging to the area “3XXX”, a terminal apparatus 1A (terminal ID “3213”) of which it knows an IP address (that is, of which the IP address is stored in the routing table which it is holding itself). In this way, the search message including the content ID, which is unique identification information corresponding to the content, the content ID is used as the destination identification information in the search message.

According to the example shown in FIG. 5, as the IP address of the terminal apparatus 1A, of which the terminal ID is “3213”, is stored in the routing table of the request terminal apparatus 1N (refer to FIG. 4), the request terminal apparatus 1N transmits the search message to the terminal apparatus 1A, of which the terminal ID is “3213”.

Next, the terminal apparatus 1A which has received the search message determines whether or not the search message is a message directed to the terminal apparatus 1A itself. The determination of whether or not it is a message directed to the terminal apparatus 1A itself is carried out based on the destination identification information and the routing table. Specifically, it is determined whether or not the destination identification information is near a terminal ID which is identification information of the terminal apparatus 1A itself. That is, the terminal apparatus 1A determines, from the terminal ID of the terminal apparatus 1 stored in the routing table (values of the table are not shown) which the terminal apparatus 1A itself is holding, whether the terminal apparatus 1 terminal ID nearest to the destination identification information is its own, or that of another terminal apparatus 1.

Then, as the terminal ID of another terminal apparatus 1 is nearer the destination identification information than the terminal ID of the terminal apparatus 1A itself, the terminal apparatus 1A refers to the level 2 table of the routing table which the terminal apparatus 1A itself is holding, and forwards the search message to, among terminal apparatus 1 belonging to the area “30XX”, a terminal apparatus 1B (terminal ID “3031”) of which it knows an IP address.

In this way, the forwarding of the search message proceeding by a procedure of matching digits of the content ID in order from a first digit, when eventually arriving at a terminal apparatus 1C which manages the content data, that is, the route terminal apparatus, the route terminal apparatus searches for the content ID “3020” included in the search message from among index information, to be described hereafter, which it manages itself, and returns information (a terminal ID, an IP address, and the like) relating to a content holding terminal apparatus which possesses the content data to the request terminal apparatus 1N. A system which forwards a message, such as the search message, in the heretofore described way until it arrives at an objective terminal apparatus 1 is called a DHT routing.

In this way, the request terminal apparatus 1N, becoming aware of the IP address, which is location information relating to the content holding terminal apparatus which holds the content data with the content ID “3020”, by receiving it from the root terminal apparatus 1C, acquires the content data by downloading them from the content holding terminal apparatus.

1.4. Method of Registering in Index Table

A description will be given of a method when, for example, in the content distribution system S with this kind of configuration, a certain terminal apparatus 1 discloses new content data in such a way as to be searchable for from another terminal apparatus 1 in the content distribution system S.

The terminal apparatus 1 which has become the content holding terminal apparatus by storing the content data distributed from the content server apparatus 10 transmits a registration message toward a terminal apparatus which has a terminal ID the same as the content ID of the stored content data (it is not known at this point whether or not this terminal apparatus actually exists). Then, the registration message too, in the same way as the heretofore described search message, being forwarded on and on in accordance with the routing table, when it has been forwarded as far as the terminal apparatus 1 which has the terminal ID nearest the content ID included in the registration message, in the event that the terminal apparatus 1 determines that there is no longer any other terminal apparatus 1 which is a forwarding destination, it determines that the terminal apparatus 1 itself should become the root terminal apparatus of the content, and stores as index information the content ID, and the terminal ID and IP address of the content holding terminal apparatus (hereafter, these will be called the “index information”), included in the registration message.

Furthermore, in the embodiment, a configuration being such that the index information included in the registration message is also held as a cache in a terminal apparatus 1 partway along a route along which the registration message is forwarded to the root terminal apparatus, this kind of terminal apparatus 1 is referred to as a cache terminal apparatus. Accordingly, it is possible for the cache terminal apparatus, at a point at which the search message is forwarded to the cache terminal apparatus, to return the IP address and terminal ID of the content holding terminal apparatus to the request terminal apparatus which is searching for the location of the content, before the root terminal apparatus receives the search message for searching for the content. In the embodiment, it is taken that at least the IP address of the content holding terminal apparatus is returned in response to the search message, but it is also acceptable to return the terminal ID along with the IP address of the content holding terminal apparatus.

When forwarding the registration message, normally, the cache terminal apparatus holds index information based on the registration message, in the way heretofore described.

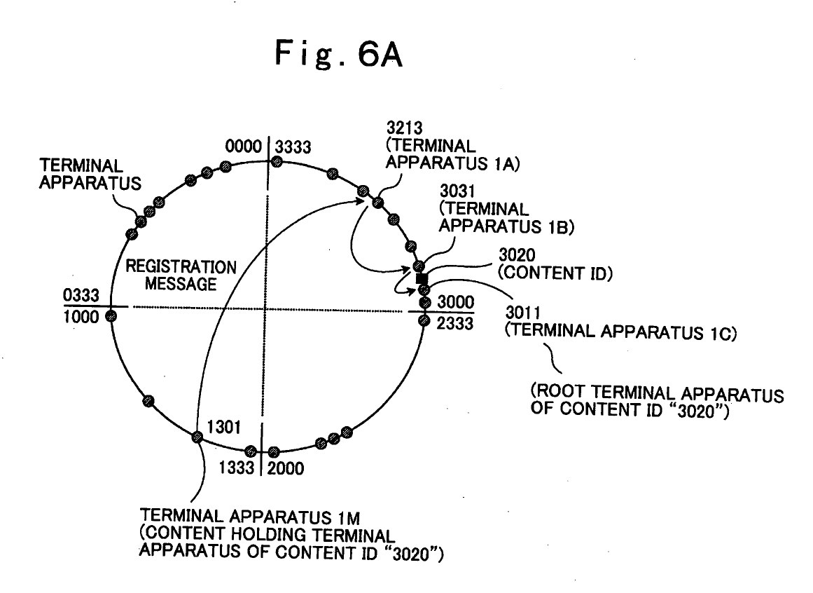

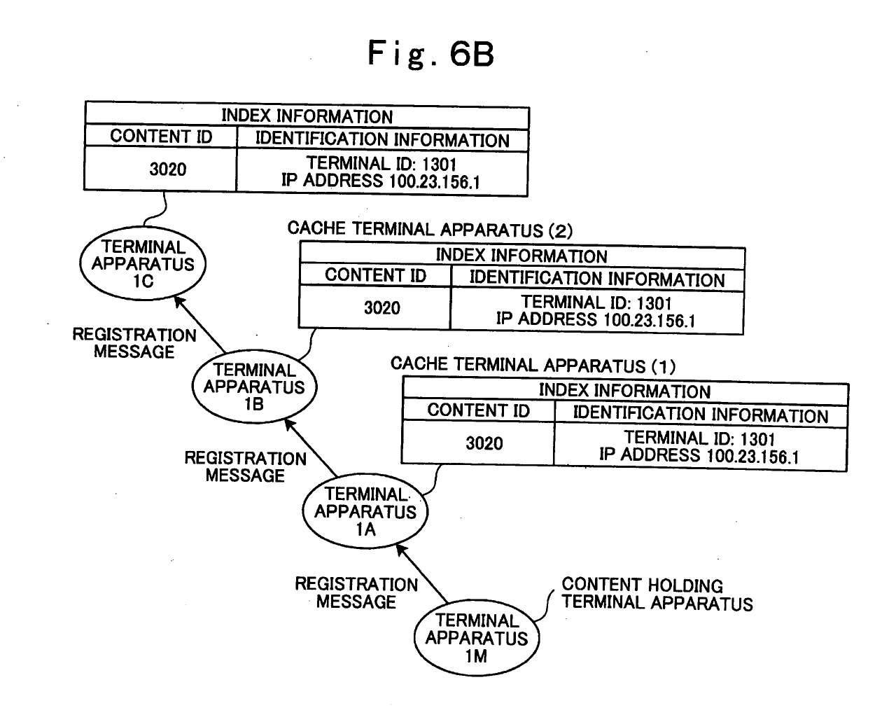

Herein, taking a terminal apparatus 1M, of which terminal ID is “1301”, to be the content holding terminal apparatus holding the content with the content ID “3020”, as shown in FIG. 6A, a description will be given, referring to FIGS. 6A and 6B, of a holding of index information in a case of taking the terminal apparatus 1C, of which the terminal ID is “3011”, to be the root terminal apparatus of the content with the content ID “3020”.

As shown in FIGS. 6A and 6B, on the terminal apparatus 1M, which is the content holding terminal apparatus, transmitting a registration message including index information, the terminal apparatus 1A, which receives the registration message, functions as a cache terminal apparatus 1 by holding the index information. The cache terminal apparatus 1 forwards the registration message. The terminal apparatus 1B, which receives the registration message, functions as a cache terminal apparatus 2 by holding the index information. The cache terminal apparatus 2 forwards the registration message. The terminal apparatus 1C, which receives the registration message, functions as the root terminal apparatus by holding the index information. In this way, the terminal apparatus 1A, 1B and 1C hold the index information included in the registration message.

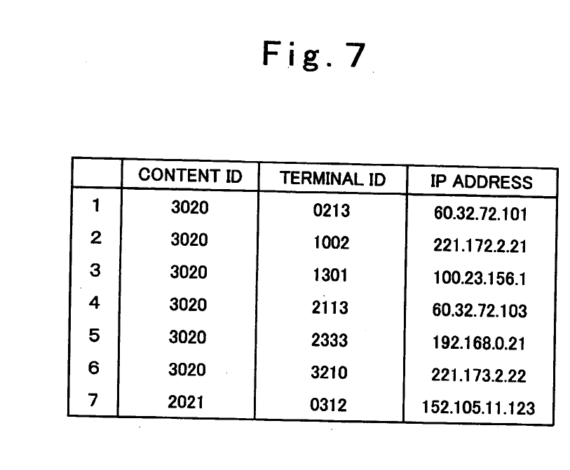

Apropos, the holding of the index information in the root terminal apparatus and the cache terminal apparatus is carried out by the kind of index table shown in FIG. 7. FIG. 7 showing an example of an index table in the root terminal apparatus 1C, the terminal apparatus 1 itself, as well as storing the terminal ID, IP address and the like of the content holding terminal apparatus relating to the content with the content ID “3020”, which are a subject of management, stores identification information of the content holding terminal apparatus relating to content with content ID “2021”, as a cache terminal apparatus. As well as the content ID, and the terminal ID and IP address of the content holding terminal apparatus, it is also possible to store copyright information and the like in the index table.

1.5. Content Holding Terminal Apparatus Disposition Method

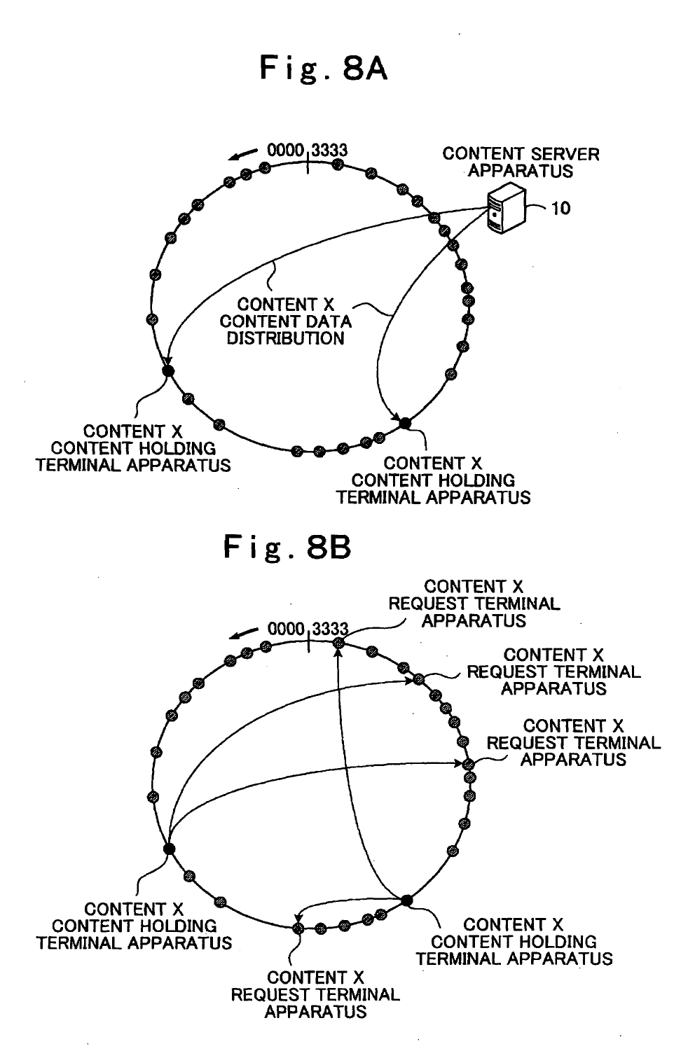

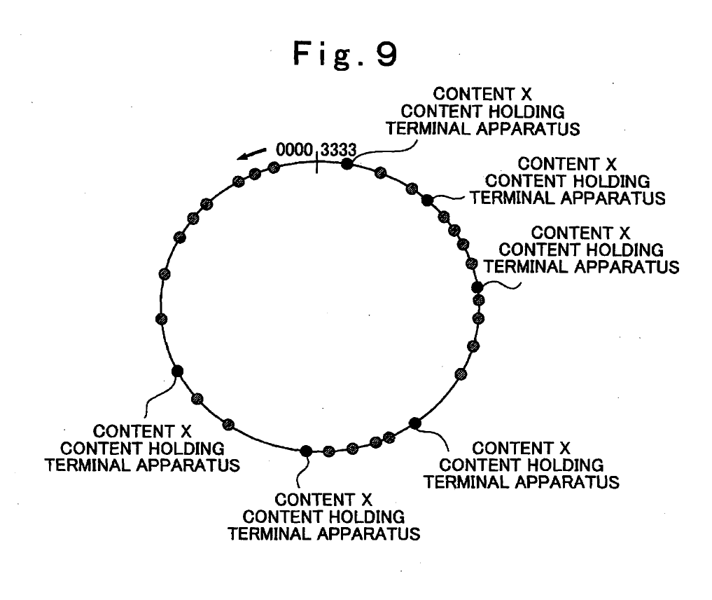

Next, a specific description will be given, referring to the drawings, of a content holding terminal apparatus disposition method in the content distribution system S. FIGS. 8A, 8B and 9 are illustrations of the content holding terminal apparatus disposition method.

In the embodiment, as one example, taking a predetermined period after content data of certain content X (hereafter called “content X data”) are introduced into the content distribution system S to be a reservation period, by increasing the content holding terminal apparatus during the reservation period, a concentrated accessing of a content holding terminal apparatus at a subsequent reservation period finishing point, occurring due to there being few content holding terminal apparatus, is avoided. The reservation period refers to a predetermined period until a time and date of a disclosure of the content X data. Also, the finishing of the reservation period, being a condition wherein the time and date of the disclosure of the content X data has been reached, refers to a condition wherein the time and date of the disclosure of the content data has come, or a condition wherein the disclosure time and date has passed.

As shown in FIG. 8A, firstly, the content X data are distributed from the content server apparatus 10 to two terminal apparatus 1 configuring the content distribution system S. Herein, the number of terminal apparatus 1 to which the content server apparatus 10 distributes the content X data is taken to be two, but it is sufficient that it is equal to or greater than one. Also, for example, it is acceptable to increase the number in the event that it can be predicted that the content X to be introduced will be popular content, or to decrease the number in the event that it can be predicted that the content X will be totally unpopular content. Whether the content X is popular or not being based, in the event that the content X is, for example, music content, on a popularity of content data introduced in the past in which a singer is the same as in the content X, the content server apparatus 10 can decide on the number of terminal apparatus 1 to which to introduce the content X data.

On the content X data being introduced in this way, a transmission and reception of the content X data among the terminal apparatus 1 becomes possible. That is, on carrying out an operation for a user of a terminal apparatus 1 which is not a content holding terminal apparatus to acquire the content X data introduced into the content distribution system S (hereafter referred to as an “acquisition request operation”. An acquisition request operation during the reservation period is peculiarly called a “reservation operation”), the terminal apparatus 1 detects the reservation operation and, as the request terminal apparatus, issues a request to the content holding terminal apparatus holding the content X data introduced from the content server apparatus 10 for a transmission of the content X data. Subsequently, as shown in FIG. 8B, the content holding terminal apparatus, which has received the request for the transmission of the content X data, transmits the content X data to the request terminal apparatus which has issued the transmission request.

Herein, the request terminal apparatus which receives the content X data from the content holding terminal apparatus stores the content X data in an internal memory, and thereafter also has a function as a content X content holding terminal apparatus (refer to FIG. 9). However, the request terminal apparatus, even in the event of receiving the content X data, cannot reproduce the content X data during the reservation period. This point will be described in detail hereafter.

In this way, every time the reservation operation is carried out in the terminal apparatus 1 during the content X reservation period, the content X data are transmitted and received among the terminal apparatus 1, and the number of content holding terminal apparatus increases.

Subsequently, on the content X reservation period finishing, a reproduction of the content X data is possible in the request terminal apparatus which has acquired the content X data during the reservation period.

Herein, as the content X data are encrypted with a predetermined encryption key, it is not possible to reproduce them as they are in the terminal apparatus 1. Consequently, in order to reproduce the content X data, the terminal apparatus 1 acquires a decryption key corresponding to the content X data (hereafter called a “content X decryption key”) from a decryption key management apparatus 20, decrypts the content X data using the decryption key, and reproduces them.

Also, content X disclosure time and date information being included in the content X data, it is possible to determine, in the terminal apparatus 1, whether or not the reservation period is finished by extracting the disclosure time and date information.

Also, when a content X data acquisition request operation is carried out by the user after the finish of the content X reservation period, the terminal apparatus 1 acquires content X data from the content holding terminal apparatus holding the content X data corresponding to the acquisition request operation, and acquires a content X decryption key from the decryption key management apparatus 20. The content X data acquired in this way are decrypted by the decryption key, and can immediately be reproduced by the terminal apparatus 1.

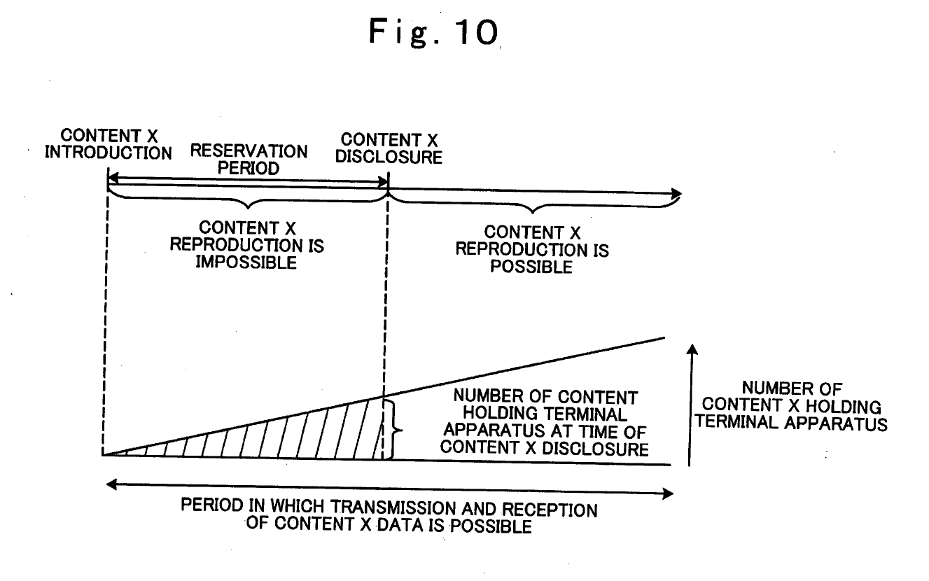

FIG. 10 shows that, after the content X is introduced into the content distribution system S in this way, the content holding terminal apparatus holding the content X data at the content X disclosure time have increased. The number of content holding terminal apparatus at the content X disclosure time increases in accordance with a number of terminal apparatus 1 in which the reservation operation is carried out. Consequently, when there is a large number of terminal apparatus 1 in which the reservation operation is carried out, there is a large number of content holding terminal apparatus at the content X disclosure time, while when there is a small number of terminal apparatus 1 in which the reservation operation is carried out, there is a small number of content holding terminal apparatus at the content X disclosure time.

Also, in the terminal apparatus 1, when it is not possible, when carrying out an action acquiring content data corresponding to the reservation operation, to acquire the content data corresponding to the acquisition action from the content holding terminal apparatus, after waiting a predetermined time, another attempt is made to acquire the content data.

As it is arranged so as to wait the predetermined time and retry the content data acquisition action in this way, it is possible to carry out the acquisition of the content data without causing a repeat of the acquisition request operation by the user.

Moreover, in the event that it is possible to carry out the retrial of the content data acquisition action in such a way that it is possible to acquire the content data within the reservation period, the user who has carried out the acquisition request operation can carry out a reproduction of the content data at the disclosure time after the reservation period finishes, meaning that, by setting the waiting time, for example, as a randomly decided time, it is possible to arrange in such a way that, as far as possible, it does not overlap with a timing of a content data acquisition action with another terminal apparatus 1, by which means it is possible to appropriately increase the content holding terminal apparatus.

Also, it is also possible to make the waiting time a time which is one half of a time remaining until the time and date of the disclosure of the content data. For example, when the time remaining until the disclosure time and date is two days, the retrial is carried out when the time remaining until the disclosure time and date is one day, and when the content data cannot be acquired by this retrial either, the retrial is carried out when the time remaining until the disclosure time and date is twelve hours. By doing this, it is possible to increase a probability of being able to acquire the content data by the disclosure time and date.

Also, it is also possible to set the waiting time as a time which is a certain time divided by a number of retrials in a content data acquisition process. For example, in the event that the certain time is taken to be twelve hours, the retrial is carried out six hours later when the retrial is a second one, and four hours later when the retrial is a third one. By doing this too, it is possible to increase the probability of being able to acquire the content data by the disclosure time and date.

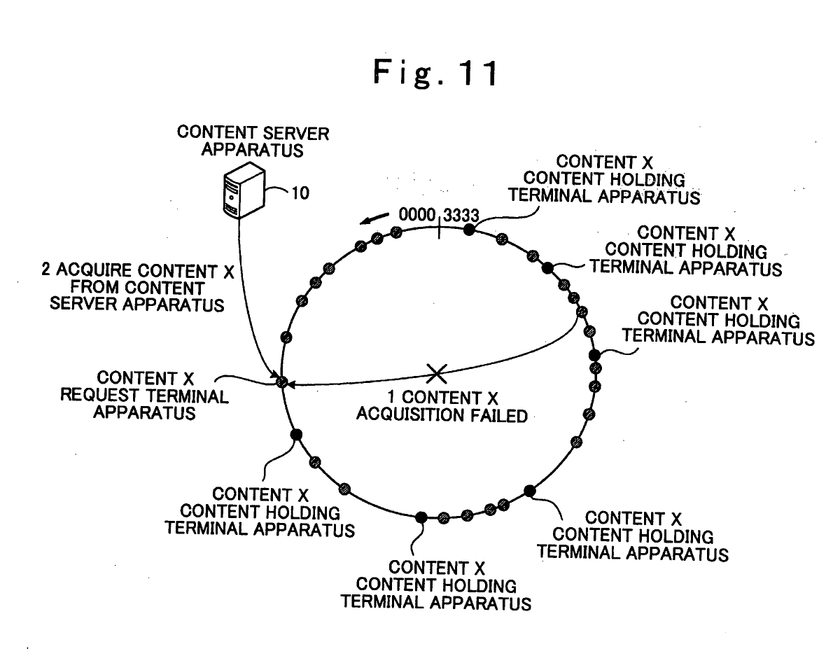

Meanwhile, with regard to the content data disclosed when the reservation period finishes, when it is not possible to acquire the content data corresponding to the acquisition action from the content holding terminal apparatus, the terminal apparatus 1 acts in such a way as to acquire the content data from the content server apparatus 10, as shown in FIG. 11, so it is possible to increase a possibility of acquiring the content data after the disclosure.

However, although a description has been given heretofore with the disclosure time and date of the content X as a content X data disclosure condition, it is also acceptable to make a plurality of groups of IP addresses, which are the location information of the terminal apparatus 1, and set the disclosure time and date for each of the groups. By doing this, it is possible to, for example, group together IP addresses allotted on a country by country basis, such as Japan, the USA, China, and the like, and change the disclosure time and date of the content X data on a country by country basis.

2. Description of Configuration and the Like of Terminal Apparatus 1

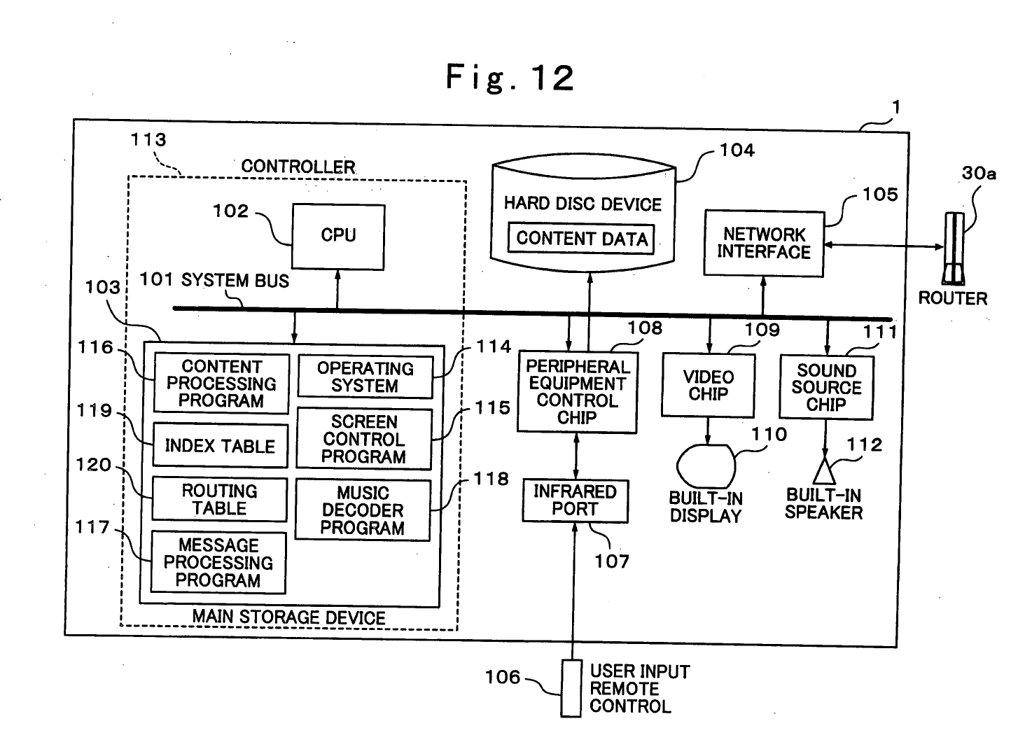

Next, a description will be given of a configuration and operations of the terminal apparatus 1, referring to the drawings. FIG. 12 is a diagram showing an outline configuration of the terminal apparatus 1 in the content distribution system S according to the embodiment.

The terminal apparatus 1, a general personal computer as well as a dedicated computer being applicable, being configured, as shown in FIG. 12, including a CPU (Central Processing Unit) 102, a first memory 103, as a rewritable main storage device which stores various kinds of program and the like, a second memory 104, configured of an HDD (Hard Disc Drive) or the like, which stores various kinds of data and the like, a network interface 105, for carrying out communication with other terminal apparatus 1 participating in the network 8 via a router 30a, a remote control 106, which transmits and receives a predetermined infrared signal for a remote operation by a user of the terminal apparatus 1, an infrared port 107 for carrying out communication with the remote control 106 by means of infrared rays, a peripheral equipment control chip 108, which controls the infrared port 107, a video chip 109 which receives image data by a control of the CPU 102, writes them into an internal video memory (not shown), and displays the data written into the video memory on a built-in display 110, to be described hereafter, the built-in display 110, a sound source chip 111 which has a sound source such as an FM sound source or a Wave Table sound source and, by transmitting an audio signal to a speaker 112, outputs a sound wave from the speaker 112, and the speaker 112, these various kinds of component are mutually connected via a system bus 101. In the embodiment, a controller 113 is configured of the CPU 102 and the first memory 103.

First Memory 103

Also, an operating system (OS) program 114 for providing basic functions of the terminal apparatus 1 as a computer, a screen control program 115 for carrying out a control, or the like, of the built-in display 110, a content processing program 116 for receiving content data transmitted from another terminal apparatus 1, which functions as a content holding terminal apparatus, and for distributing content data stored in the second memory 104 when the terminal apparatus 1 itself functions as the content holding terminal apparatus, a message processing program 117 for carrying out a transmission and reception of messages with another terminal apparatus 1, a music decoder program 118 for carrying out a reproduction, and the like, of distributed content data, and the like being stored in the first memory 103, they are retrieved by the CPU 102, and functions according to the programs are executed by the CPU 102. Also, an index table storage area 119 for storing an index table (refer to FIG. 7), and a routing table storage area 120 for storing a routing table (refer to FIG. 4), are further provided in the first memory 103.

Herein, the OS program 114, by being retrieved and executed by the CPU 102, renders executable functions relating to an input and output of the remote control 106, and the basic functions of the computer, which is the terminal apparatus 1, such as a memory management of the first memory 103, the second memory 104, and the like. Then, in a condition in which the OS program 114 is executed by the CPU 102, the heretofore described screen control program 115, content processing program 116, message processing program 117, music decoder program 118, and the like, are retrieved from the first memory 103, and executed.

It is also acceptable that the OS program 114, screen control program 115, content processing program 116, message processing program 117, music decoder program 118, and the like are, for example, downloaded via the network interface 105 into the first memory 103 from a server, or the like, connected to the network 8, and it is also acceptable that, after being recorded on a recording medium such as a CD-ROM, they are loaded into the first memory 103 via an unshown recording medium drive.

Second Memory 104

The second memory 104 has a catalog list storage area which stores a catalog list, in which names, disclosure conditions, and the like of content introduced from the content server apparatus 10, and provided in the content distribution system S, are listed, a content data storage area functioning as a content data storage module, which stores content data distributed from the content server apparatus 10, or the like, and so on.

Controller 113

The controller 113, being configured, as heretofore described, of the CPU 102 and first memory 103, centrally controls a whole of the terminal apparatus 1 by the CPU 102 retrieving and executing the various kinds of program 114 to 118 stored in the first memory 103, as well as functioning as a display control module, a content data acquisition request detection module, a content data acquisition module, a content data transmission module, a disclosure condition acquisition module, a disclosure condition determination module, a decryption key request module, a decryption key acquisition module, a decoding module, a content data reproduction module, a message destination determination module, a message forwarding module, a registration message transmission module, a content holding terminal apparatus information acquisition module, a terminal apparatus identification information transmission module, and the like, to be described hereafter.

The controller 113 functions as the display control module, and the like, by the CPU 102 executing the screen control program 115, also, as the content data acquisition request detection module, content data acquisition module, content data transmission module, disclosure condition acquisition module, disclosure condition determination module, decryption key request module, decryption key acquisition module, content data reproduction module and the like, by the CPU 102 executing the content processing program 116, also, as the message destination determination module, message forwarding module, registration message transmission module, content holding terminal apparatus information acquisition module, terminal apparatus identification information transmission module, and the like, by the CPU 102 executing the message processing program 117, and also, as the decoding module, and the like, by the CPU 102 executing the music decoding program 118.

Display Control Module

The display control module, controlling the video chip 109 and built-in display 110, has a function of displaying various kinds of image information (graphical information). That is, the display control module controls in what way an image is displayed on the built-in display 110.

Content Data Acquisition Request Detection Module

The content data acquisition request detection module detects a content data acquisition request operation by the user. For example, when a catalog list which the terminal apparatus 1 has acquired from the content server apparatus 10 is displayed by the display control module on the built-in display 110, by the user of the terminal apparatus 1 operating the remote control 106, the content data acquisition request operation is performed by the user selecting a desired content name from the catalog list being displayed, and the operation is detected by the content data acquisition request detection module.

As well as information for identifying content data, such as names of content distributable in the content distribution system S, disclosure condition information for each item of content data being included in the catalog list, the display control module, based on the content data disclosure condition information, displays a list of the content names included in the catalog list, whether they are being disclosed, and whether they are in the reservation period, on the built-in display 110. Furthermore, in the event of being in the reservation period, the display control module also carries out a display of the disclosure time and date. Consequently, it is possible for the user of the terminal apparatus 1 to easily ascertain which of the content distributable in the content distribution system S is being disclosed, and which is in the reservation period.

Content Data Acquisition Module

When a message received via the network interface 105 is a content data holding request from the content server apparatus 10, the content data acquisition module acquires the content data from the content server apparatus 10. Then, the content data acquisition module stores the acquired content data in the second memory 104, which is the content data storage module.

Also, when the acquisition request operation by the user is detected by the content data acquisition request detection module, the content data acquisition module acquires the content data corresponding to the acquisition request operation from another terminal apparatus 1, via the network 8.

Herein, when acquiring the content data from another terminal apparatus 1, the content data acquisition module generates a search message for searching for location information of a content holding terminal apparatus which is holding the content data it is attempting to acquire. The search message is a message which makes a content ID, which is identification information of the requested content data, destination identification information, and makes a terminal ID, which is identification information of the terminal apparatus 1 itself, request source identification information. The content data acquisition module retrieves, from the catalog list, the content name of the content data it is trying to acquire, and decides on the content ID by hashing the retrieved content name with the same hash function as when acquiring the terminal ID. It is also acceptable to include in advance content ID corresponding to the content data in the catalog list in the content server apparatus 10.

The content data acquisition module, selecting a transmission destination terminal apparatus which satisfies a predetermined condition, based on the content ID which is the destination identification information of the generated search message, transmits the search message. Herein, the “predetermined condition” is a condition by which the content data acquisition module selects a terminal ID, among the terminal ID stored in the routing table, of which the most leading digits match the content ID, which is the destination identification information of the search message. For example, in the event of having the kind of routing table shown in FIG. 4, and of the content ID, as the destination identification information, being “1231”, a content holding terminal request information transmission module selects the terminal ID “1221” from the routing table as the transmission destination terminal apparatus, and retrieves the IP address “21.13.21.13” of the terminal apparatus 1 with the terminal ID “1221”. Then, the content holding terminal request information transmission module transmits a search message with the IP address “21.13.21.13” as the transmission destination terminal apparatus.

In this way, the content data acquisition module generates a search message with the content ID decided on, or the content ID generated based on the content name included in the catalog list, as the destination identification information. Subsequently, the content data acquisition module selects the transmission destination terminal apparatus from the terminal apparatus 1 identification information stored in the routing table, and forwards the generated search message to the transmission destination terminal apparatus. That is, the content data acquisition module selects a terminal ID, among the terminal apparatus 1 terminal ID stored in the routing table, which is near the destination identification information, becomes aware of the IP address of the terminal apparatus 1 corresponding to the terminal ID selected in this way, and transmits the search message to the terminal apparatus 1 with that IP address.

The content data acquisition module receives the location information of the content holding terminal apparatus transmitted from the root terminal apparatus in response to the transmitted search message and, based on this information, makes a request to the content holding terminal apparatus for the content data corresponding to the acquisition request operation, and acquires them.

Also, when the content data corresponding to the acquisition request operation cannot be acquired from another terminal apparatus 1 via the network 8, the content data acquisition module, after waiting the predetermined time, once more carries out the process of acquiring the content data corresponding to the acquisition request operation.

Herein, the predetermined time being a randomly decided time, the content data acquisition module calculates it using a pseudorandom algorithm or a random number generating circuit.

Also, it is also acceptable, as heretofore described, to make the predetermined time a time which is one half of the time remaining until the disclosure time and date, or to make it a time which is a certain time divided by the number of retrials in the content data acquisition process. Also, it is also acceptable to make the predetermined time a constant time.

Also, the content data acquisition module, even when it is not possible to acquire the content data corresponding to the acquisition request operation from another terminal apparatus 1, when the disclosure condition thereof is met, acquires the content data corresponding to the acquisition request operation from the content server apparatus 10 holding the content data corresponding to the acquisition request operation.

The acquisition of the content data from the content server apparatus 10 is carried out by the content data acquisition module transmitting a content transmission request including the content ID of the content data corresponding to the acquisition request operation.

Content Data Transmission Module

When there has been a request from another terminal apparatus 1 for a transmission of the content data stored in the second memory 104, which is the content data storage module, the content data transmission module retrieves the content data corresponding to the transmission request from the second memory 104, and transmits them to the another terminal apparatus 1 which has made the transmission request.

Disclosure Condition Acquisition Module

The disclosure condition acquisition module acquires the disclosure condition information of the content data acquired by the content data acquisition module.

The disclosure condition information of the content data, being information on the disclosure time and date of the content data, is included in the content data acquired by the content data acquisition module. The disclosure condition acquisition module acquires the disclosure condition by extracting the disclosure condition information included in the content data acquired by the content data acquisition module.

The disclosure condition information for each item of content data being included in the catalog list, as heretofore described, it is also acceptable that the disclosure condition acquisition module acquires the disclosure condition information of the content data acquired from the catalog list by the content data acquisition module.

Disclosure Condition Determination Module

The disclosure condition determination module, based on the disclosure time and date information, which is the disclosure condition information acquired by the disclosure condition acquisition module, determines whether or not the content data acquired by the content data acquisition module meet the disclosure condition.

For example, in the event that the disclosure time and date information of the content data acquired by the content data acquisition module is “10 a.m. on Aug. 10, 2006”, the disclosure condition determination module determines that the content data acquired by the content data acquisition module do not meet the disclosure condition when the current time is earlier than 10 a.m. on Aug. 10, 2006, and that they meet the disclosure condition in the event that the current time is 10 a.m. on Aug. 10, 2006 or later.

It is also possible to make the content data disclosure condition acquired by the disclosure condition acquisition module one in which, in addition to the content disclosure time and date, the IP address, which is the location information of the terminal apparatus 1, is also added. That is, the disclosure condition acquisition module acquires the disclosure time and date, and the IP address of the terminal apparatus 1 which reproduces the content data, as the disclosure condition information, and the disclosure condition determination module, based on the disclosure time and date and IP address, determines whether or not the content data acquired by the content data acquisition module meet the disclosure condition. For example, by giving IP addresses “60.32.72.XXX” to “60.32.79.XXX” the disclosure time and date of 10:00 a.m. on Aug. 10, 2006, and IP addresses “60.32.80.XXX” to “60.32.89.XXX” a disclosure time and date of 10:00 a.m. on Aug. 11, 2006, as the disclosure condition information, it is possible to change the disclosure time and date for each group of IP addresses.

Decryption Key Request Module

The content data acquired by the content data acquisition module being encrypted content data, the decryption key request module, in the event that it has been determined by the disclosure condition determination module that the disclosure condition thereof has been met, makes a request to the decryption key management apparatus 20 for a decryption key corresponding to the content data which meet the disclosure condition.

When it is not possible to acquire the decryption key from the decryption key management apparatus 20, it is acceptable to request the decryption key from the root terminal apparatus of the content which meets the disclosure condition. In this case, the decryption key management apparatus 20 transmits the decryption key of content data, among content data which it possesses itself, determined to meet the disclosure condition, to the root terminal apparatus.

Decryption Key Acquisition Module

The decryption key acquisition module acquires the decryption key transmitted from the decryption key management apparatus 20 in response to the request from the decryption key request module.

Also, when it is not possible to acquire the decryption key from the decryption key management apparatus 20, it is acceptable to acquire the decryption key from the root terminal apparatus of the content which meets the disclosure condition.

Decoding Module

The decoding module decodes the content data stored in the second memory 104 in order to display them on the built-in display 110, or output them from the speaker 112. That is, content data transmitted from another terminal apparatus 1 being encoded in a predetermined format, the decoding module decodes the content data encoded in this way in such a way that they can be displayed on the built-in display 110 or output from the speaker 112.

Content Data Reproduction Module

The content data reproduction module reproducing content data, among the content data stored in the second memory 104, determined by the disclosure condition determination module to meet the disclosure condition, after decrypting the content data stored in the second memory 104 with the decryption key acquired by the decryption key acquisition module, decodes them with the decoding module, and reproduces the content data by causing the video chip 109 and sound source chip 111 to act.

Message Destination Determination Module

The message destination determination module, based on destination identification information of a message received via the network 8 and on the routing table, determines whether or not the message received is addressed to its own terminal apparatus 1. A message judged by the message destination determination module is a search message for requesting content holding terminal apparatus identification information from the root terminal apparatus, a registration message for registering the content holding terminal apparatus identification information in the root terminal apparatus, or the like.

The determination of whether or not the message received is addressed to its own terminal apparatus 1 is such that the controller 113, to be described hereafter, retrieves the destination identification information included in the message, and determines based on the routing table stored in the first memory 103. That is, when receiving various kinds of message via the network interface 105, the message destination determination module compares the destination identification information included in the message received and the terminal ID stored in the routing table and, on determining that the terminal ID in the routing table nearest to the destination identification information included in the message is the terminal ID of its own terminal apparatus 1, determines that it is a message addressed to its own terminal apparatus 1.

Message Forwarding Module

The message forwarding module, on it being determined by the message destination determination module that the message received via the network 8 is not addressed to its own terminal apparatus 1, selects a transmission destination terminal apparatus from the terminal apparatus 1 identification information stored in the routing table, based on the destination identification information of the message received, and forwards the message received to the transmission destination terminal apparatus. That is, the message forwarding module selects a terminal ID, among the terminal apparatus 1 terminal ID stored in the routing table, which is near the destination identification information, becomes aware of the IP address of the terminal apparatus 1 corresponding to the terminal ID selected in this way, and forwards the message with the IP address as a destination of an IP packet.

Registration Message Transmission Module

The registration message transmission module, when storing the content data received from the content server apparatus 10 in the second memory 104, which is the content data storage module, generates a registration message including the terminal ID and IP address, which are the identification information of its own terminal apparatus 1, with the content ID, which is the identification information of the content data, as the destination identification information. Also, when receiving the content data from another content data holding terminal apparatus too, in the same way, the registration message transmission module stores the content data received in the second memory 104, which is the content data storage module, and generates a registration message.

The registration message transmission module transmits the registration message generated in this way to a transmission destination terminal apparatus selected based on the routing table. For example, in the event of having the kind of routing table shown in FIG. 4, and of the content ID of the content data stored in the second memory 104 being “1231”, the registration message transmission module selects the terminal ID “1221” from the routing table as the transmission destination terminal apparatus, and retrieves the IP address “21.13.21.13” of the terminal apparatus 1 with the terminal ID “1221”. Then, the registration message transmission module transmits a registration message with the IP address “21.13.21.13” as the transmission destination terminal apparatus. The destination identification information of the registration message is “1231”.

Content Holding Terminal Apparatus Information Acquisition Module

The content holding terminal apparatus information acquisition module, when a message received in its own terminal apparatus 1 is a registration message, acquires the terminal ID, IP address, and the like, which is the content holding terminal apparatus identification information included in the registration message. Then, the content holding terminal information acquisition module stores the index information acquired in this way in the index table.

Terminal Apparatus Identification Information Transmission Module

The terminal apparatus identification information transmission module, in the event that the terminal ID of the content holding terminal apparatus corresponding to the content requested by the search message is being stored, transmits the IP address, which is the location information of the content holding terminal apparatus, toward the request terminal apparatus which has transmitted the search message.

3. Description of Configuration and the Like of Content Server Apparatus 10

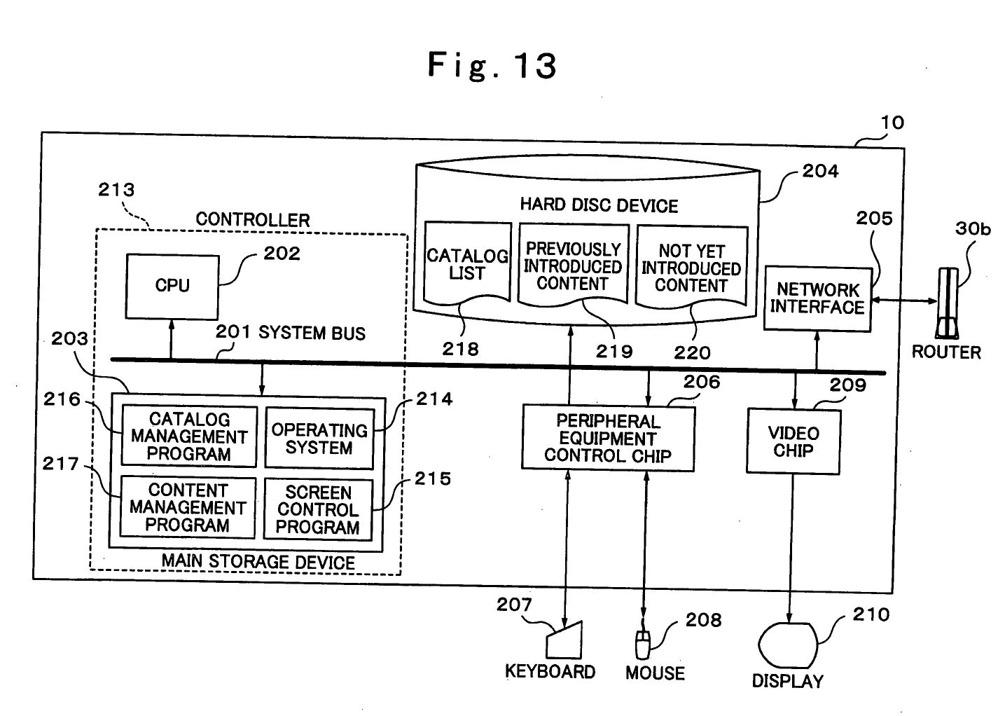

Next, a description will be given of a configuration and operations of the content server apparatus 10, referring to the drawings. FIG. 13 is a diagram showing an outline configuration of the content server apparatus 10 in the content distribution system S according to the embodiment.

The content server apparatus 10, a general server computer as well as a dedicated computer being applicable, being configured, as shown in FIG. 13, including a CPU (Central Processing Unit) 202, a first memory 203, as a rewritable main storage device which stores various kinds of program and the like, a second memory 204, configured of an HDD or the like, which stores various kinds of data and the like, a network interface 205, for carrying out communication with other terminal apparatus 1 participating in the network 8, via a router 30b, a keyboard 207 and a mouse 208, which are an input module for inputting information for carrying out a control of the content server apparatus 10 by a manager of the content distribution system S, a peripheral equipment control chip 206 for processing the information input from the input module, a video chip 209 which receives image data by a control of the CPU 202, writes them into an internal video memory (not shown), and displays the data written into the video memory on a display 210, to be described hereafter, the display 210, and the like, these various kinds of component are mutually connected via a system bus 201. In the embodiment, a controller 213 is configured of the CPU 202 and the first memory 203.

First Memory 203

Also, an operating system (OS) program 214 for providing basic functions of the content server apparatus 10 as a computer, a screen control program 215 for carrying out a control, or the like, of the display 210, a catalog management program 216 for managing a catalog list, which is a list of content, and updating the catalog list every time content is introduced into the content distribution system S, a content management program 217 for newly introducing content data into the content distribution system S, and transmitting the content data in response to a request from the terminal apparatus 1, and the like being stored in the first memory 203, they are retrieved by the CPU 202, and functions according to the programs are executed by the CPU 202. “Introducing content into the content distribution system S” refers to the content server apparatus 10 deciding on a terminal apparatus 1 which is to be a first content holding terminal apparatus for certain content data, and distributing the content data to the terminal apparatus 1 decided on.

Herein, the OS program 214, by being retrieved and executed by the CPU 202, renders executable functions relating to the keyboard 207 and the mouse 208, and the basic functions of the computer, which is the content server apparatus 10, such as a memory management of the first memory 203, the second memory 204, and the like. Then, in a condition in which the OS program 214 is executed by the CPU 202, the heretofore described screen control program 215, catalog management program 216, content management program 217, and the like, are retrieved from the first memory 203, and executed.

It is also acceptable that the OS program 214, screen control program 215, catalog management program 216, content management program 217, and the like are, for example, downloaded via the network interface 205 into the first memory 203 from a server, or the like, connected to the network 8, and it is also acceptable that, after being recorded on a recording medium such as a CD-ROM, they are loaded into the first memory 203 via an unshown recording medium drive.

Second Memory 204

The second memory 204 has a catalog list storage area 218, which stores a catalog list in which are listed names and disclosure condition information of content generated by a catalog updating program, and provided within the content distribution system S, a previously introduced content data storage area 219, which stores the content provided in the content distribution system S, and a not yet introduced (new) content data storage area 220, which stores content data to be newly introduced.

Controller 213

The controller 213, being configured, as heretofore described, of the CPU 202 and first memory 203, centrally controls a whole of the content server apparatus 10 by the CPU 202 retrieving and executing the various kinds of program 214 to 217 stored in the first memory 203, as well as functioning as a display control module, a content introduction module, a content transmission module, a catalog list updating module, a catalog list distribution module, and the like, to be described hereafter.

The controller 213 functions as the display control module and the like, by the CPU 202 executing the screen control program 215, also, as the catalog list updating module, catalog list distribution module, and the like, by the CPU 202 executing the catalog management program 216, and also, as the content introduction module, content transmission module, and the like, by the CPU 202 executing the content management program 217.

Display Control Module

The display control module, controlling the video chip 209 and display 210, has a function of displaying various kinds of image information (graphical information). That is, the display control module controls in what way an image is displayed on the display 210.

Content Introduction Module

The content introduction module has a function of deciding on content ID, which is identification information of content data to be newly introduced into the content distribution system S. More specifically, the content introduction module obtains a random value by means of a random calculation, and decides on the content ID by hashing the value randomly obtained in this way with the same hash function as when acquiring the terminal ID.

Also, the content introduction module has a function of randomly deciding on a terminal apparatus 1 to be caused to hold content data stored in the new content data storage area 220, that is, a content holding terminal apparatus.

Also, it is acceptable that a number of content holding terminal apparatus which the content introduction module randomly decides on is, for example, two, as heretofore described or, in the event that it is possible to predict the popularity of the content to be introduced, it is possible, as heretofore described, to increase or decrease depending on the predicted popularity.

Also, the content introduction module issues a request to the content holding terminal apparatus decided on to hold the content data. The content data holding request, in the embodiment, being a request for causing the terminal apparatus 1 to be made the content holding terminal apparatus, decided on as heretofore described, hold the content data, it is transmitted by a DHT routing. In response to the request, the terminal apparatus 1 which is to be the content holding terminal apparatus retrieves the IP address of the content server apparatus 10 from the content data holding request, and transmits a request, addressed to the IP address, for a transmission of content data corresponding to the holding request. The content introduction module, on receiving the content data transmission request, transmits the content data to be held to the transmission request source terminal apparatus 1.

Content Transmission Module

The content transmission module, in the event that there is a request for a transmission of content data from a terminal apparatus 1 via the network, retrieves content data corresponding to the transmission request from the second memory 204, which is a content storage module, and transmits them to the request source terminal apparatus 1. However, when the reservation period of the content requested by the terminal apparatus 1 is not finished, the content transmission module transmits a notification to the terminal apparatus 1 which has issued the transmission request to the effect that it is not possible to transmit the content data.

Catalog List Updating Module

The catalog list updating module updates the catalog list stored in the second memory 204 every time content data is newly introduced into the content distribution system S by the content introduction module.

The updating of the catalog list is carried out by correlating, as well as information for specifying the content data, such as a name, of the newly introduced content, content disclosure condition information, and adding it to the catalog list.

Catalog List Distribution Module

The catalog list distribution module, in response to a catalog list distribution request from a terminal apparatus 1, retrieves the catalog list stored in the second memory 204, and distributes it to the terminal apparatus 1 which has issued the distribution request.

4. Description of Configuration and the Like of Decryption Key Management Apparatus 20

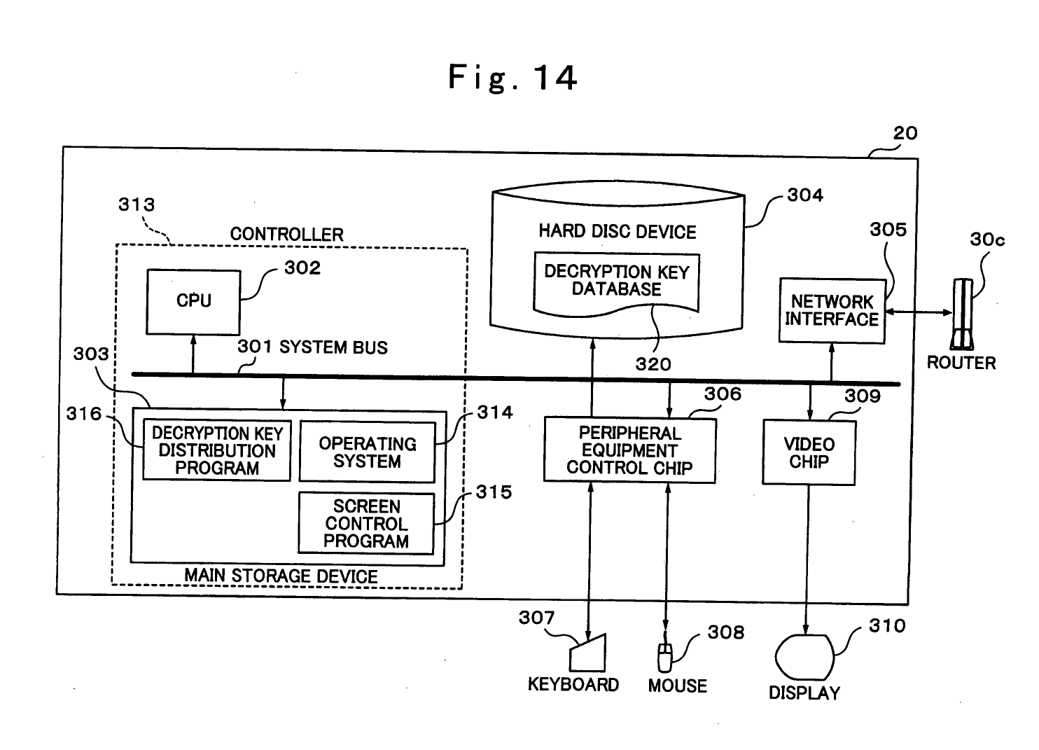

Next, a description will be given of a configuration and operations of the decryption key management apparatus 20, referring to the drawings. FIG. 14 is a diagram showing an outline configuration of the decryption key management apparatus 20 in the content distribution system S according to the embodiment.

The decryption key management apparatus 20, a general server computer as well as a dedicated computer being applicable, being configured, as shown in FIG. 14, including a CPU (Central Processing Unit) 302, a first memory 303, as a rewritable main storage device which stores various kinds of program and the like, a second memory 304, configured of an HDD or the like, which stores various kinds of data and the like, a network interface 305, for carrying out communication with other terminal apparatus 1 participating in the network 8, via a router 30c, a keyboard 307 and a mouse 308, which are an input module for inputting information for carrying out a control of the decryption key management apparatus 20 by the manager of the content distribution system S, a peripheral equipment control chip 306 for processing the information input from the input module, a video chip 309 which receives image data by a control of the CPU 302, writes them into an internal video memory (not shown), and displays the data written into the video memory on a display 310, to be described hereafter, the display 310, and the like, these various kinds of component are mutually connected via a system bus 301. In the embodiment, a controller 313 is configured of the CPU 302 and the first memory 303.

First Memory 303

Also, an operating system (OS) program 314 for providing basic functions of the decryption key management apparatus 20 as a computer, a screen control program 315 for carrying out a control, or the like, of the display 310, a decryption key distribution program 316 for distributing a content data decryption key to the terminal apparatus 1, and the like being stored in the first memory 303, they are retrieved by the CPU 302, and functions according to the programs are executed by the CPU 302.

Herein, the OS program 314, by being retrieved and executed by the CPU 302, renders executable functions relating to the keyboard 307 and the mouse 308, and the basic functions of the computer, which is the decryption key management apparatus 20, such as a memory management of the first memory 303, the second memory 304, and the like. Then, in a condition in which the OS program 314 is executed by the CPU 302, the heretofore described screen control program 315, decryption key distribution program 316, and the like, are retrieved from the first memory 303, and executed.

It is also acceptable that the OS program 314, screen control program 315, decryption key distribution program 316, and the like are, for example, downloaded via the network interface 305 into the first memory 303 from a server, or the like, connected to the network 8, and it is also acceptable that, after being recorded on a recording medium such as a CD-ROM, they are loaded into the first memory 303 via an unshown recording medium drive.

Second Memory 304

The second memory 304 has a decryption key database area 320 which functions as a decryption key storage module in which are stored decryption keys, for decrypting content data introduced from the content server apparatus 10 and provided in the content distribution system S, correlated to a content ID of each item of content data.

Controller 313

The controller 313, being configured, as heretofore described, of the CPU 302 and first memory 303, centrally controls a whole of the decryption key management apparatus 20 by the CPU 302 retrieving and executing the various kinds of program 314 to 316 stored in the first memory 303, as well as functioning as a display control module, a decryption key transmission module, and the like, to be described hereafter.

The controller 313 functions as the display control module and the like, by the CPU 302 executing the screen control program 315, and also, as the decryption key transmission module and the like, by the CPU 302 executing the decryption key distribution program 316.

Display Control Module

The display control module, controlling the video chip 309 and display 310, has a function of displaying various kinds of image information (graphical information). That is, the display control module controls in what way an image is displayed on the display 310.

Decryption Key Transmission Module

The decryption key transmission module, when there is a request from a terminal apparatus 1, via the network 8, for a decryption key, retrieves the decryption key from the second memory 304, and transmits it to the request source terminal apparatus 1.

Content ID being included in the decryption key request from the terminal apparatus 1, the decryption key transmission module retrieves a decryption key corresponding to the content ID from the decryption key database of the second memory 304.

5. Operations of Content Distribution System S

Hereafter, a more specific description will be given, using flowcharts, of detailed operations of the terminal apparatus 1, the content server apparatus 10, and the decryption key management apparatus 20.

Description of Terminal Apparatus 1 Process Flow

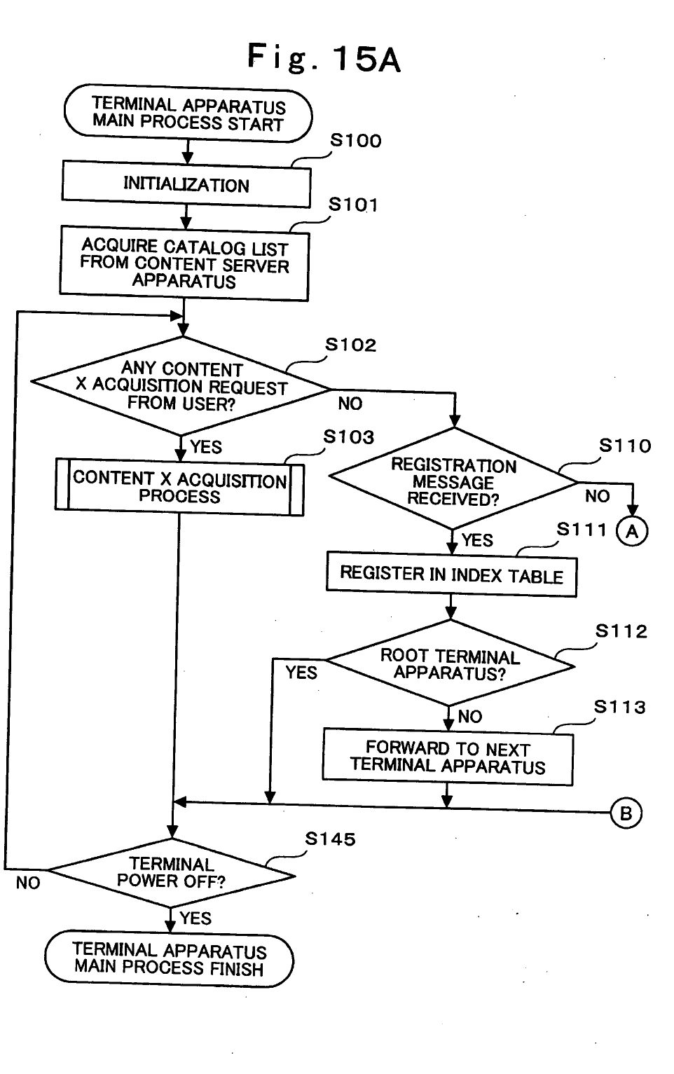

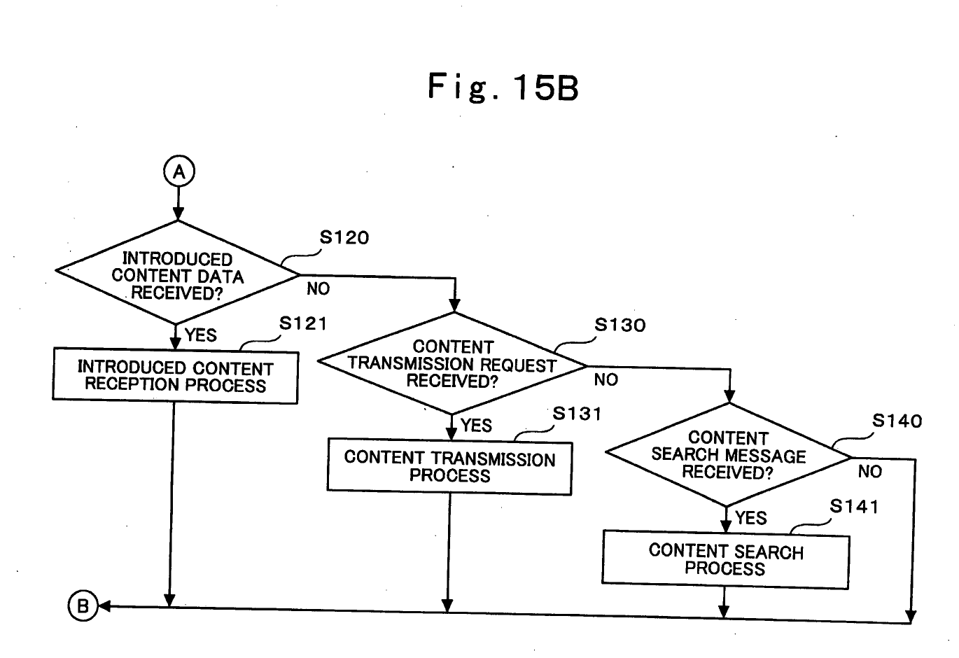

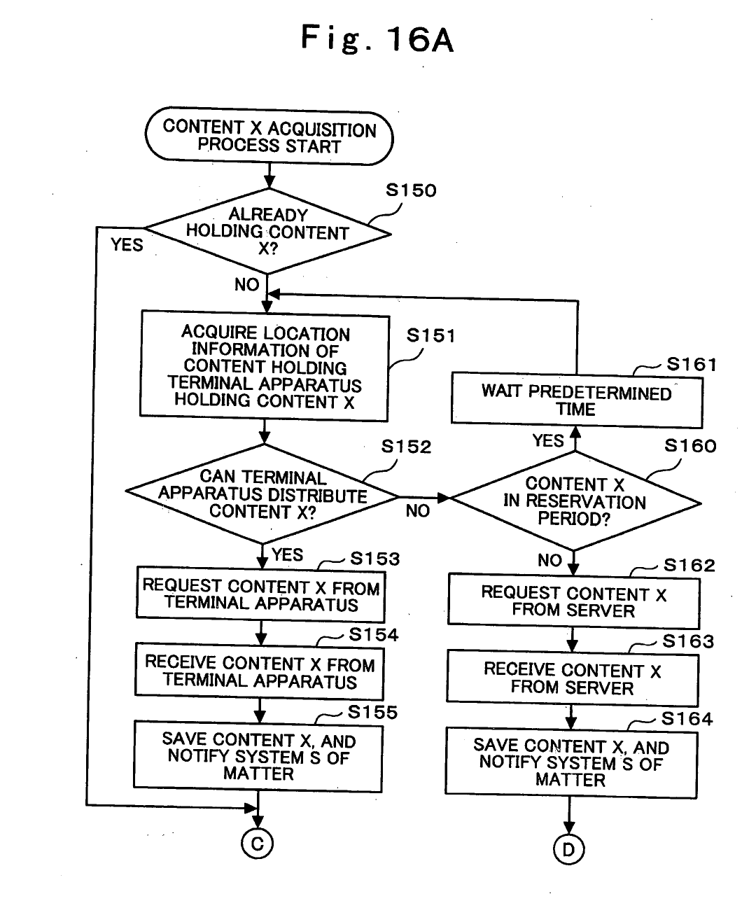

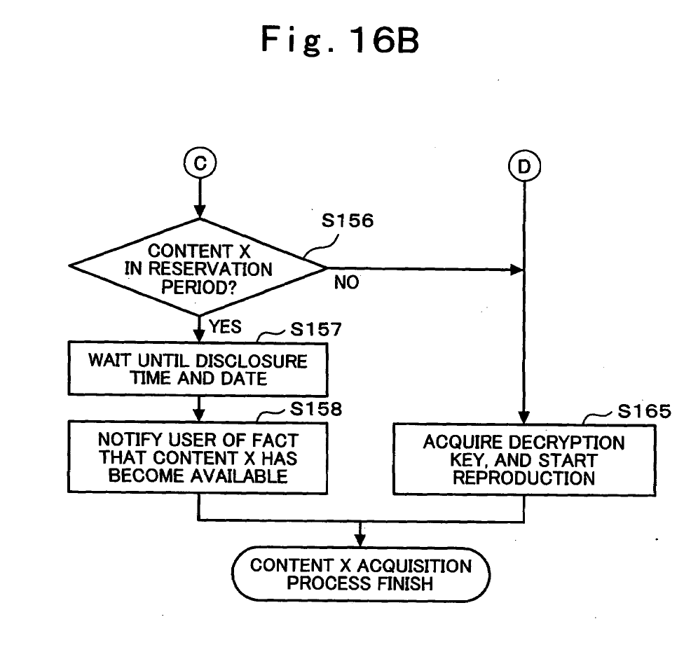

Firstly, a description will be given, referring to the flowcharts of FIGS. 15 and 16, of a more specific operation of the terminal apparatus 1. FIGS. 15 and 16 are flowcharts showing processes in the terminal apparatus 1. Each of the following processes is executed by the controller 113 of the terminal apparatus 1 functioning as the heretofore described modules, and the like.

As shown in FIG. 15, on power of the terminal apparatus 1 being turned on, the CPU 102 of the terminal apparatus 1 executes initial setting operations, such as permitting an access to the first memory 103 and second memory 104, and initializing a securing of a working area, puts each program 115 to 118 into a condition in which it is executed by the CPU 102 and, after starting up a function as the controller 113 (step S100), moves the process to step S101.

In step S101, the controller 113 acquires a catalog list from the content server apparatus 10. The acquisition of the catalog list is carried out by the controller 113 requesting the catalog list from the content server apparatus 10, and receiving the catalog list transmitted in response to the request. Also, the controller 113 thereafter regularly acquires a catalog list from the content server apparatus 10.

Information in which are correlated names and the like of a plurality of items of content data which can be acquired, as heretofore described, in the content distribution system S, and disclosure condition information, is included in the catalog list. The controller 113 acquires the catalog list from the content server apparatus 10, and displays details of the catalog list on the built-in display 110. The user of the terminal apparatus 1 can carry out an acquisition of content data in the content distribution system S by carrying out an operation of the remote control 106, or the like, while looking at the details of the catalog list displayed on the built-in display 110.

Herein, the controller 113, if it determines, based on the catalog list, that the content is in the reservation period, displays the fact that the content is in the process of accepting reservations, and a “reservation button”, on the built-in display 110. Meanwhile, if it determines, based on the catalog list, that the content is not in the reservation period, the controller 113 displays the fact that the content is in the process of being disclosed, and a “download button”, on the built-in display 110. When the “reservation button” or the “download button” are selected by the remote control 106, or the like, the controller 113 determines that there has been a content acquisition request operation by the user.

Next, in step S102, the controller 113 determines whether or not there has been an acquisition request operation by the user for arbitrary content X. Whether or not there has been a content X acquisition request operation by the user is judged depending on whether or not an operation instructing a content acquisition (a depression of the “reservation button” or the “download button”) has been performed, as heretofore described, by a content selection module such as the remote control 106.

In the process, if it is determined that there has been an acquisition request operation by the user for the content X (step S102: Yes), the controller 113 shifts to a content X acquisition process (step S103). The process of step S103, being processes S150 to S158, and S160 to S165, in FIG. 16, will be described in detail hereafter.

Conversely, if it is determined, in step S102, that there has been no acquisition request operation by the user for the content X (step S102: No), the controller 113 determines whether or not a registration message has been received (step S110). Whether or not a registration message has been received is judged depending on whether or not a registration message transmitted from a content holding terminal apparatus, via the network 8, has been received by its own terminal apparatus 1.

In the process, if it is determined that a registration message has been received (step S110: Yes), the controller 113 correlates the location information of the content holding terminal apparatus included in the registration message received, and the content ID, and the like, of the content data held by the content holding terminal apparatus, and adds them to the index table of the first memory 103 (step S111).

Subsequently, the controller 113 determines whether or not its own terminal apparatus 1 is the root terminal apparatus (step S112). Whether or not the terminal apparatus 1 is the root terminal apparatus is judged based on the destination identification information of the registration message received, and on the routing table stored in the first memory 103.

If it is determined, in the process, that the terminal apparatus 1 is not the root terminal apparatus (step S112: No), the controller 113, based on the routing table stored in the first memory 103, forwards the registration message to another terminal apparatus 1 (step S113). Conversely, if it is determined that the terminal apparatus 1 is the root terminal apparatus (step S112: Yes), the controller 113 does not carry out the process of step S113.

If it is determined, in step S110, that no registration message has been received (step S110: No), the controller 113 determines whether or not the introduced content data have been received (step S120).

In the process, if it is determined that content data introduced from the content server apparatus 10 have been received (step S120: Yes), the controller 113 carries out an introduced content reception process (step S121).

The introduced content reception process, as well as saving the content data introduced from the content server apparatus 10 by storing them in the second memory 104, registers them in the index table of the root terminal apparatus.

That is, the controller 113 stores the introduced content data received in step S120 in the content data storage area of the second memory 104, and saves them. Also, when it is determined that its own terminal apparatus 1 is not the root terminal apparatus, the controller 113, based on the routing table, transmits the registration message to another terminal apparatus 1 via the network 8, while when it is determined that its own terminal apparatus 1 is the root terminal apparatus, the controller 113 adds the content ID and the location information of its own terminal apparatus 1 to the index table, and registers them.

If it is determined, in step S120, that the introduced content data have not been received (step S120: No), the controller 113 determines whether or not there is a content data transmission request from another terminal apparatus 1 (step S130).

If it is determined, in the process, that there has been a content data transmission request from another terminal apparatus 1 (step S130: Yes), the controller 113 retrieves content data corresponding to the content data transmission request from the second memory 104, and transmits the retrieved content data to the another terminal apparatus 1 which has issued the transmission request (step S131).

Also, if it is determined, in the process, that there has been no content data transmission request from another terminal apparatus 1 (step S130: No), the controller 113 determines whether or not a search message has been received (step S140). Whether or not a search message has been received is judged depending on whether or not a search message transmitted from the request terminal apparatus, via the network 8, has been received.

If it is determined, in the process, that a search message has been received (step S140: Yes), the controller 113 carries out a content search process in step S141.

In the content search process, firstly, the controller 113 acquires the content ID from the search message received in step S141, and determines whether or not the content ID exists in the index table. Then, if it is determined that the content ID acquired from the search message exists in the index table, the controller 113 acquires the location information of the content holding terminal apparatus from the index table, and transmits the location information of the content holding terminal apparatus to the request terminal apparatus, via the network 8. Conversely, if it is determined that the content ID acquired from the search message does not exist in the index table, the controller 113, based on the routing table, forwards the message to the next terminal apparatus 1, via the network 8.

When it is determined, in step S140, that no search message has been received (step S140: No), when it is determined, in step S112, that its own terminal apparatus 1 is not the root terminal apparatus (step S112: Yes), or when the process of step S103, step S113, step S121, step S131 or step S141 is finished, the controller 113 determines whether or not the power of its own terminal apparatus 1 has shifted to an off condition (step S145).

If it is determined, in step S145, that the power of its own terminal apparatus 1 has shifted to the off condition (step S145: Yes), the controller 113 finishes the main process, while if it is determined that the power of its own terminal apparatus 1 has not shifted to the off condition (step S145: No), the controller 113 repeats the process from step S102.

Next, a specific description will be given, referring to the flowchart of FIG. 16, of the content X acquisition process in S103.

As shown in FIG. 16, on the content X acquisition process being started, the controller 113 determines whether or not the content X data are already held in the second memory 104 (step S150).

If it is determined, in step S150, that the content X data are not being held in the second memory 104 (step S150: No), the controller 113, in order to acquire the location information of the content holding terminal apparatus which is holding the content X data, transmits a search message, which has the content X content ID as the destination identification information, based on the routing table stored in the first memory 103.

The search message arrives at the content X root terminal apparatus by means of the DHT routing of the content distribution system S. In response to the search message, the root terminal apparatus transmits the location information of the content holding terminal apparatus which is holding the content X data, the controller 113 acquires the location information of the content holding terminal apparatus, which is holding the content X data, transmitted from the root terminal apparatus (step S151), and determines whether or not the content holding terminal apparatus which is holding the content X data can transmit the content X data (step S152).

In the process, the controller 113 makes an inquiry to the content holding terminal apparatus which is holding the content X data as to whether or not it can transmit the content X data and, based on information, transmitted from the content holding terminal apparatus in response to the inquiry, regarding the possibility or otherwise of transmitting the content X data, determines whether or not the content holding terminal apparatus can transmit the content X data.

If it is determined, in step S152, that the content holding terminal apparatus can carry out a transmission of the content X data (step S152: Yes), the controller 113 shifts the process to step S153.

In step S153, the controller 113 makes a request, to the content X content holding terminal apparatus, for a transmission of the content X data, receives the content X data transmitted from the content holding terminal apparatus in response to the request (step S154), and shifts the process to step S155.

In step S155, the controller 113 stores the received content X data in the second memory 104, and notifies the content distribution system S of the matter. That is, the controller 113, as the content X content holding terminal apparatus, transmits a registration message to the content X root terminal apparatus.

Next, the controller 113 shifts the process to step S156, and determines whether or not the content X stored in the second memory 104 is in the reservation period.

In the process, the controller 113 carries out a determination of whether or not the content X is in the reservation period, based on the content X disclosure time and date information included in the content X data stored in the second memory 104. That is, the controller 113, by extracting the disclosure time and date information, determines whether the content X is in the reservation period, or whether the reservation period is finished. It is also acceptable to carry out the determination of whether or not the content X is in the reservation period based on the disclosure time and date information, which is the content X disclosure condition information included in the catalog list.

If it is determined, in step S156, that the content X is in the reservation period (step S156: Yes), the controller 113 delays the reproduction of the content X data until the disclosure time and date (step S157).

When reaching the content X disclosure time and date, the controller 113 shifts the process to step S157, and notifies the user of the fact that the content X has become available (step S158).

Herein, the notification of the fact that the content X has become available is executed by the controller 113 carrying out a display on the built-in display 110 of the fact that the content X has become available. Subsequently, when there has been a content X reproduction request operation, by means of an operation by the user of the remote control 106 or the like, the controller 113 acquires the content X decryption key from the decryption key management apparatus 20. That is, the controller 113 issues a request to the decryption key management apparatus 20 for a transmission of the content X decryption key, and receives the decryption key transmitted from the decryption key management apparatus 20 in response to the transmission request. The controller 113 decrypts the content X data stored in the second memory 104 using the decryption key acquired, putting the content X data into a condition in which they are reproducible in the terminal apparatus 1. Then, after the decrypted content X data are decoded by the controller 113, the content X data are reproduced by causing the video chip 109 and sound source chip 111 to operate.

Meanwhile, if it is determined, in step S156, that the content X is not in the reservation period (step S156: No), the controller 113 acquires the content X decryption key from the decryption key management apparatus 20. The operation of acquiring the content X decryption key from the decryption key management apparatus 20 is as heretofore described.

The controller 113, by decrypting the content X data stored in the second memory 104 using the decryption key acquired, puts the content X data into a condition in which they are reproducible in the terminal apparatus 1. Then, after the decrypted content X data are decoded by the controller 113, the content X data are reproduced by causing the video chip 109 and sound source chip 111 to operate (step S165).

Also, if it is determined, in step S152, that the content holding terminal apparatus cannot carry out a transmission of the content X data (step S152: No), the controller 113 shifts the process to step S160.

In step S160, the controller 113 determines whether or not the content X is in the reservation period.

In the process, the controller 113 carries out the determination of whether or not the content X is in the reservation period based on the content X disclosure time and date information included in the catalog list. That is, the controller 113, by extracting the disclosure time and date information, determines whether the content X is in the reservation period, or whether the reservation period is finished. If it is determined that the content X is in the reservation period (step S160: Yes), the controller 113, after waiting the predetermined time (step S161), shifts to the process of step S151, and carries out a retrial of the content X acquisition operation.

Conversely, if it is determined, in step S160, that the content X is not in the reservation period (step S160: No), the controller 113 requests the content server apparatus 10 to transmit the content X data (step S162), receives the content X data transmitted from the content server apparatus 10 in response to the request (step S163), and shifts the process to step S164.

In step S164, the controller 113 stores the content X data received in the second memory 104, and notifies the content distribution system S of the fact. That is, the controller 113, as the content X content holding terminal apparatus, transmits a registration message to the root terminal apparatus. Subsequently, the controller 113 shifts the process to step S165.

When the process of step S158 or the process of step S165 finishes, the controller 113 finishes the content X acquisition process.

In this way, while the terminal apparatus 1 according to the embodiment acquires content data corresponding to the user's acquisition request operation, via the network, from another terminal apparatus 1, stores them, and transmits the content data stored in this way in response to a transmission request from another terminal apparatus 1, it is possible, it being arranged in such a way that the reproduction of the content data is carried out when the acquired content data meet the disclosure condition thereof, to appropriately dispose content holding terminal apparatus by the time the content data are disclosed. Consequently, it is possible to avoid accesses concentrating on a specific content holding terminal apparatus when the content data are disclosed. Also, as the content data are stored in the terminal apparatus 1 when the content data disclosure condition has been met, it is possible to carry out the reproduction of the content data promptly.

Description of Content Server Apparatus 10 Process Flow

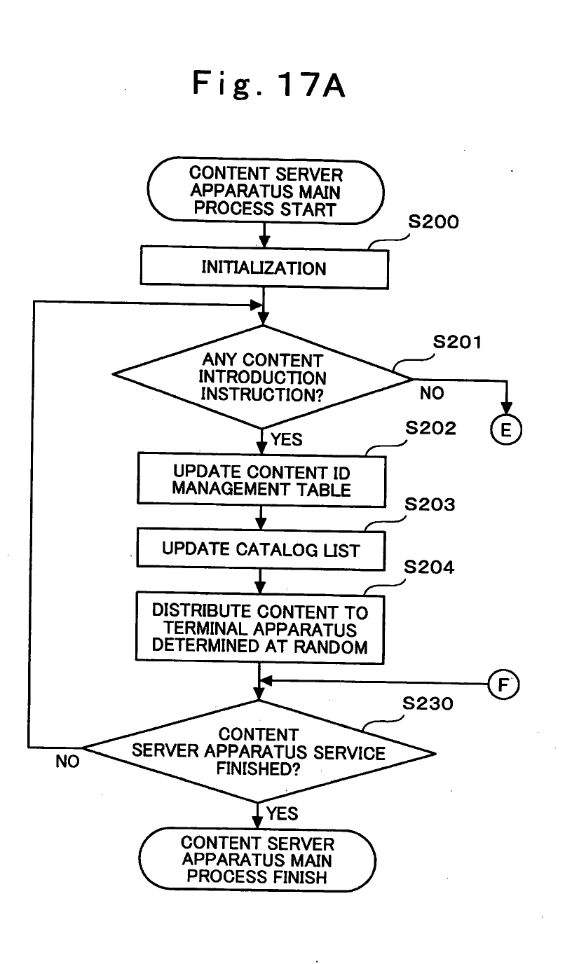

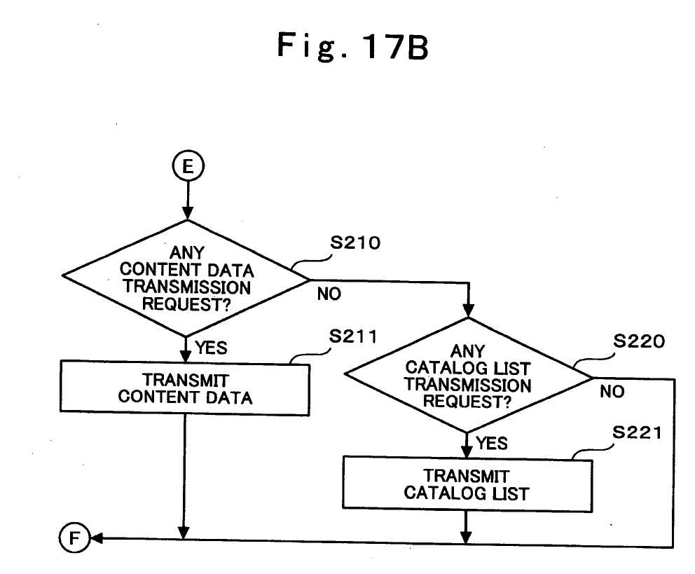

Next, a description will be given, referring to FIG. 17, of a more specific operation of the content server apparatus 10. FIG. 17 is a flowchart showing a whole of a process in the content server apparatus 10. Each of the following processes is executed by the controller 213 of the content server apparatus 10 functioning as the heretofore described modules, and the like.

On power of the content server apparatus 10 being turned on, the CPU 202 of the content server apparatus 10 executes initial setting operations, such as, permitting an access to the first memory 203 and second memory 204, and initializing a securing of a working area, puts each program 214 to 217 into a condition in which it is executed by the CPU 202 and, after starting up a function as the controller 213 (step S200), moves the process to step S201.

In step S201, the controller 213 determines whether or not there is a content introduction instruction. Herein, the controller 213 judges whether or not there is a content introduction instruction depending on whether or not a content introduction operation has been performed by an operation by the user of an input module such as the keyboard 207 or the mouse 208. The content introduction instruction is issued by specifying the content data by the name of the content.

If it is determined, in the process, that there is a content introduction instruction (step S201: Yes), the controller 213, after storing the content ID corresponding to the content data specified by the content introduction instruction in a management table of the second memory 204 (step S202), shifts the process to step S203. A plurality of items of content data and content ID stored in the second memory 204 are stored correlated in the management table, and furthermore, for each item of content data stored in the second memory 204, a flag is stored correlated to each content, indicating whether or not it has been introduced to the content holding terminal apparatus. The flags include a not yet introduced flag (a flag value is “0”), and a previously introduced flag (a flag value is “1”) %.

In step S203, the controller 213 updates the catalog list, and shifts the process to step S204. The updating of the catalog list is carried out by additionally storing the disclosure condition information and content name corresponding to the content data specified by the content introduction instruction in the catalog list stored in the second memory 204.

In step S204, the controller 213, in order to make the content data specified by the content introduction instruction distributable by the content distribution system S, randomly decides on one or more terminal apparatus 1 to be the content holding terminal apparatus of the content data specified by the content introduction instruction. The controller 213 transmits the content data specified by the content introduction instruction, via the network 8, to the terminal apparatus 1 decided on in this way (step S203).

Conversely, if it is determined, in step S201, that there is no content introduction instruction (step S201: No), the controller 213 determines whether or not there has been a content data transmission request from the terminal apparatus 1. The content data transmission request is made by specifying the content data by the name, content ID, or the like, of the content.

If it is determined, in the process, that there has been a content data transmission request from the terminal apparatus 1 (step S210: Yes), the controller 213 determines whether or not the content data corresponding to the content data transmission request meet the disclosure condition. That is, the controller 213 determines whether or not the reservation period of the content corresponding to the transmission request is finished. If it is determined that the reservation period is finished, the controller 213 retrieves the content data corresponding to the transmission request from the second memory 204, and transmits them to the terminal apparatus 1 via the network 8 (step S211). Conversely, if it is determined that the reservation period of the content corresponding to the transmission request is not finished, the controller 213 transmits a notification of the fact that it is not possible to transmit the content data to the terminal apparatus 1 which has issued the transmission request.

Also, if it is determined, in step S210, that there has been no content data transmission request from the terminal apparatus 1 (step S210: No), the controller 213 determines whether or not there has been a request from the terminal apparatus 1 for a transmission of the catalog list (step S220).

If it is determined, in the process, that there has been a request from the terminal apparatus 1 for a transmission of the catalog list (step S220: Yes), the controller 213 retrieves the catalog list stored in the second memory 204. The controller 213 transmits the catalog list, via the network 8, to the terminal apparatus 1 which has issued the catalog list transmission request (step S221).

When the process of step S204, S211 or S221 is finished, or when it is determined, in step S220, that there is no request from the terminal apparatus 1 for a transmission of the catalog list (step S220: No), the controller 213 determines whether or not a content server apparatus 10 service finishing operation has been carried out (step S230). If it is determined that the service finishing operation has not been carried out (step S230: No), the controller 213 repeats the process from step S201, while if it is determined that the content server apparatus 10 service finishing operation has been carried out (step S230: Yes), the controller 213 finishes the process.

In the way heretofore described, the content server apparatus 10 introducing the content data by transmitting them to the terminal apparatus 1 configuring the content distribution system S, it is possible to manage the content data introduced into the content distribution system S by the content server apparatus 10. Also, the content server apparatus 10 generates and updates the catalog list, and transmits it in response to a request from the terminal apparatus 1, by which means the terminal apparatus 1 easily acquires the content data distributed in the content distribution system S.

In the content server apparatus 10 according to the embodiment, as it is arranged in such a way as to transmit, in response to a request from the terminal apparatus 1, the content data for which the reservation period is finished, it is possible to promptly distribute the content after the disclosure (herein, after the reservation period finishes).

Description of Decryption Key Management Apparatus 20 Process Flow

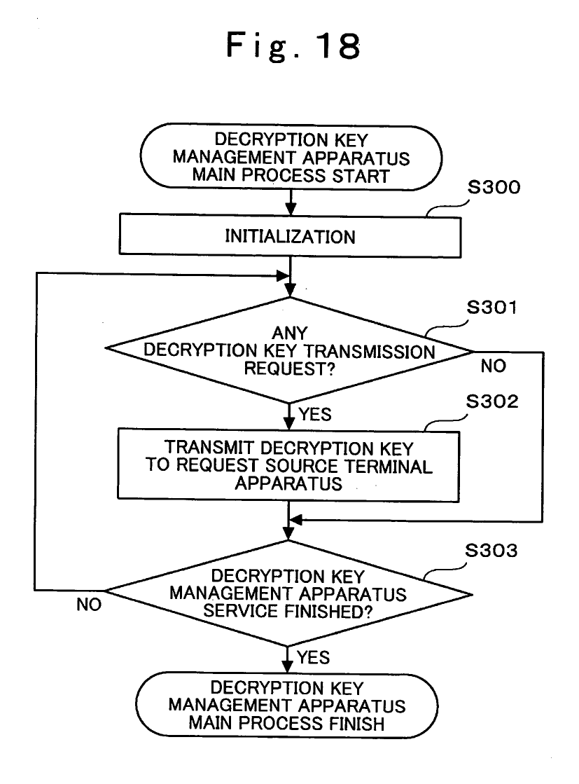

Next, a description will be given, referring to FIG. 18, of a more specific operation of the decryption key management apparatus 20. FIG. 18 is a flowchart showing a whole of a process in the decryption key management apparatus 20. Each of the following processes is executed by the controller 313 of the decryption key management apparatus 20 functioning as the heretofore described modules, and the like.

On power of the decryption key management apparatus 20 being turned on, the CPU 302 of the decryption key management apparatus 20 executes initial setting operations, such as permitting an access to the first memory 303 and second memory 304, and initializing a securing of a working area, puts each program 314 to 316 into a condition in which it is executed by the CPU 302 and, after starting up a function as the controller 313 (step S300), moves the process to step S301.

In step S301, the controller 313 determines whether or not there is a request, from the terminal apparatus 1, for a transmission of the decryption key (step S301). Herein, whether or not there is a decryption key transmission request is judged depending on whether or not the controller 313 has received, via the network 8, a decryption key transmission request transmitted from the terminal apparatus 1. Information (for example, the name or content ID of the content) specifying the content data to be decrypted is included in the decryption key transmission request.

If it is determined, in the process, that there is a decryption key transmission request (step S301: Yes), the controller 313 transmits the decryption key corresponding to the transmission request to the terminal apparatus 1 which has issued the decryption key transmission request (step S302).

The decryption key to be transmitted to the terminal apparatus 1 is retrieved by the controller 313 from the decryption key database of the second memory 304, based on the information specifying the content data included in the decryption key transmission request.

Herein, the controller 313, based on the information specifying the content data included in the decryption key transmission request, retrieves the content data disclosure condition thereof from the decryption key database of the second memory 304, transmits the decryption key when the content data disclosure condition has been met, but does not transmit the decryption key when the content data disclosure condition has not been met. That is, the controller 313 transmits the decryption key when it determines that the disclosure time and date, which is the content data disclosure condition, has been reached, but does not transmit the decryption key when it determines that the disclosure time and date has not been reached.

In this way, as it is arranged in such a way as not to transmit the decryption key when the content data corresponding to the decryption key transmission request do not meet the disclosure condition, it not being possible to carry out a reproduction of content data which do not meet the disclosure condition in the terminal apparatus 1, it is possible to appropriately carry out the disclosure of the content data.

When the process of step S302 is finished, or when it is determined, in step S301, that there is no decryption key transmission request (step S301: No), the controller 313 determines whether or not a decryption key management apparatus 20 service finishing operation has been carried out (step S303). If it is determined that the service finishing operation has not been carried out (step S303: No), the controller 313 repeats the process from step S301, while if it is determined that the decryption key management apparatus 20 service finishing operation has been carried out (step S303: Yes), the controller 313 finishes the process.

In this way, the decryption key management apparatus 20 in the embodiment storing decryption keys which decrypt encrypted content data, when there is a request from the terminal apparatus 1, via the network, for a decryption key, in the event that it is determined that the content corresponding to the decryption key meets the disclosure condition, the decryption key management apparatus 20 retrieves the decryption key from the decryption key storage module, and transmits it to the request source terminal apparatus 1. As a result, it not being possible to carry out a reproduction of content data which do not meet the disclosure condition in the terminal apparatus 1, it is possible to appropriately carry out the disclosure of the content data.

As heretofore described, in the content distribution system S in the embodiment, a period from newly introducing content data until immediately before the disclosure time and date are reached is taken to be the reservation period, a display is carried out to the effect that the content data in the reservation period are, based on the catalog list, in the process of accepting reservations and, the distribution of the decryption key from the decryption key management apparatus 20 not being carried out either, it is not possible to reproduce the content data in the terminal apparatus 1.

Meanwhile, in the event that the user of the terminal apparatus 1 carries out an operation requesting an acquisition of the content in the reservation period, a transmission and reception of the content data is carried out within the content distribution system S, and the content data are stored in a plurality of terminal apparatus 1 by the finish of the reservation period.

However, as the reproduction of the content data is not carried out during the reservation period, a prompt transmission and reception of the content data not being necessary, it is sufficient that it is possible to acquire the content data by the time the reservation period finishes. Consequently, even when it is not possible to acquire the content data, by retrying the content acquisition operation by means of retrying the content data acquisition process after waiting the predetermined period, it becomes possible to carry out the acquisition of the content data, without troubling the user, even when a condition once becomes such that the acquisition of the content data is impossible.

Also, as it is arranged in such a way as to show the user of the terminal apparatus 1, by means of the catalog list or the like, that the content data are in the reservation period, it is possible to avoid a concentration of accesses for acquiring the content data, and meanwhile, as a condition immediately after the content reservation period finishing is such that it is possible to appropriately increase the content holding terminal apparatus in accordance with a reservation condition, it is possible to suppress an occurrence of a concentration of accesses after the content reservation period finishes.

In this way, with the content distribution system S in the embodiment, as it is possible to dispose the content holding terminal apparatus based on users' requests, it is possible to provide a content distribution system S which can be used more efficiently than when introducing content data from the content server apparatus 10, and disposing content holding terminal apparatus calculated in advance.

Also, in the heretofore described embodiment, the root terminal apparatus transmits the content data location information to the request terminal apparatus, and the request terminal apparatus acquires the content data by downloading them from the content holding terminal apparatus, but it is also acceptable to arrange in such a way that the root terminal apparatus requests the content holding terminal apparatus to transmit the content data to the request terminal apparatus.

Also, a format of the content distribution system S has been described with a Pastry type of content distribution system as an example but, not being limited to this, the invention is also applicable to a content distribution system such as a kademlia type, a chord type, a Viceroy type, or a CAN type, which have differing message forwarding methods.

Also, in the heretofore described embodiment, a description has been given of an aspect wherein content data are introduced from the content server apparatus 10 to the terminal apparatus 1, but it is also possible to apply the invention to a P2P distribution system wherein the content data are disclosed in the terminal apparatus 1, without using the content server apparatus 10, and the disclosed content data are transmitted and received among the terminal apparatus 1. In this case, without providing the content server apparatus 10, the content data are disclosed along with the name thereof, by the user of the terminal apparatus 1 storing the content data and the content name in a predetermined area of the second memory 204, after which the transmission and reception of the content data is carried out among the terminal apparatus 1, in the same way as in the heretofore described embodiment.

Also, the invention is not limited to the heretofore described embodiment. The heretofore described embodiment being an exemplification, any embodiment having essentially the same configuration as the technological idea described in the claims of the invention, and achieving the same effect, is encompassed in the technological scope of the invention in whatsoever case.

Also, all disclosures of Japanese Patent Application (No. 2006-237056), including specifications, claims, drawings and abstract, filed on Aug. 31, 2006, are incorporated herein by reference.

Although the embodiment and modification of the present invention have been described in detail herein, the scope of the invention is not limited thereto. It will be appreciated by those skilled in the art that various modifications may be made without departing from the scope of the invention. Accordingly, the embodiment and modification disclosed herein are only exemplary. It is to be understood that the scope of the invention is not to be limited hereby, but is to be determined by the claims which follow.

What is claimed is:

1. A content distribution system comprising: a plurality of terminal apparatus disposed dispersed in a network, the system carrying out a transmission and reception of content data among the terminal apparatus, wherein
each terminal apparatus includes:
a content data acquisition request detection module which detects a content data acquisition request operation by a user;
a content data acquisition module which, when the acquisition request operation is detected by the content data acquisition request detection module, acquires the content data corresponding to the acquisition request operation from another terminal apparatus, via the network;
a content data storage module which stores the content data acquired by the content data acquisition module;
a content data transmission module which, when there has been a request from another terminal apparatus for a transmission of the content data stored in the content data storage module, transmits content data corresponding to the transmission request to the another terminal apparatus;
a disclosure condition acquisition module which acquires disclosure condition information of the content data acquired by the content data acquisition module;
a disclosure condition determination module which, based on the disclosure condition information acquired by the disclosure condition acquisition module, determines whether or not the content data acquired by the content data acquisition module meet a disclosure condition thereof; and
a content data reproduction module which carries out a reproduction of content data determined by the disclosure condition determination module to meet the disclosure condition.

2. The content distribution system according to claim 1, wherein
the disclosure condition information being content data disclosure time and date information,
the disclosure condition determination module, when the content data acquired by the content data acquisition module are content data which have reached their disclosure time and date, or content data which have exceeded the disclosure time and date, determines that they meet the disclosure condition.

3. The content distribution system according to claim 1, further comprising:
a decryption key management apparatus which includes a decryption key storage module storing a decryption key which decrypts encrypted content data, and a decryption key transmission module which, in the event that there is a request from the terminal apparatus, via the network, for the decryption key, retrieves the decryption key from the decryption key storage module, and transmits it to the request source terminal apparatus, wherein
the terminal apparatus further includes:
a decryption key request module which, in the event that the content data acquired by the content data acquisition module are encrypted content data, and are determined by the disclosure condition determination module to meet their disclosure condition, requests a decryption key corresponding to the content data which meet the disclosure condition of the decryption key management apparatus; and
a decryption key acquisition module which acquires the decryption key transmitted from the decryption key management apparatus in response to the request from the decryption key request module, and wherein
the content data reproduction module, after the content data acquired by the content data acquisition module are decrypted with the decryption key acquired by the decryption key acquisition module, reproduces the content data.

4. The content distribution system according to claim 1, still further comprising:
a content server apparatus which includes a content storage module storing a plurality of content data, and a content transmission module which, in the event that there is a content data transmission request from the terminal apparatus, via the network, retrieves content data from the content storage module, and transmits them to the request source terminal apparatus, wherein
the terminal apparatus content data acquisition module, when it is not possible to acquire the content data corresponding to the acquisition request operation, via the network, from another terminal apparatus, once more carries out the process of acquiring the content data corresponding to the acquisition request operation, after waiting a predetermined time.

5. A terminal apparatus for use as one of a plurality of terminal apparatus in a content distribution system which, including a plurality of the terminal apparatus disposed dispersed in a network, carries out a transmission and reception of content data among the terminal apparatus, the terminal apparatus comprising:
a content data acquisition request detection module which detects a content data acquisition request operation by a user;
a content data acquisition module which, when the acquisition request operation is detected by the content data acquisition request detection module, acquires the content data corresponding to the acquisition request operation from another terminal apparatus, via the network;
a content data storage module which stores the content data acquired by the content data acquisition module;
a content data transmission module which, when there has been a request from another terminal apparatus for a transmission of the content data stored in the content data storage module, transmits content data corresponding to the transmission request to the another terminal apparatus;
a disclosure condition acquisition module which acquires disclosure condition information of the content data acquired by the content data acquisition module;
a disclosure condition determination module which, based on the disclosure condition information acquired by the disclosure condition acquisition module, determines whether or not the content data acquired by the content data acquisition module meet a disclosure condition thereof; and
a content data reproduction module which carries out a reproduction of content data determined by the disclosure condition determination module to meet the disclosure condition.

6. The terminal apparatus according to claim 5, wherein
the disclosure condition information being included in the content data,
the disclosure condition acquisition module, by extracting the disclosure condition information included in the content data acquired by the content data acquisition module, acquires the disclosure condition.

7. The terminal apparatus according to claim 5, wherein
the disclosure condition information being content data disclosure time and date information,
the disclosure condition determination module, when the content data acquired by the content data acquisition module are content data which have reached their disclosure time and date, or content data which have exceeded the disclosure time and date, determines that they meet the disclosure condition.

8. The terminal apparatus according to claim 7, wherein
the content data acquisition module, when it is not possible to acquire the content data corresponding to the acquisition request operation from the another terminal apparatus, once more carries out the process of acquiring the content data corresponding to the acquisition request operation, after waiting a predetermined time.

9. The terminal apparatus according to claim 8, wherein the predetermined time is a randomly decided time.

10. The terminal apparatus according to claim 8, wherein
the predetermined time is a time which is one half of a time remaining until the disclosure time and date.

11. The terminal apparatus according to claim 8, wherein
the predetermined time is a time which is a certain time divided by a number of retrials in the content data acquisition process.

12. The terminal apparatus according to claim 5, further comprising:
a notification module which, in the event that it is determined by the disclosure condition determination module that the content data corresponding to the reproduction request do not meet their disclosure condition, notifies of the fact when the content data corresponding to the reproduction request have met their disclosure condition.

13. The terminal apparatus according to claim 5, still further comprising:
a decryption key request module which, in the event that the content data acquired by the content data acquisition module are encrypted content data, and are determined by the disclosure condition determination module to meet their disclosure condition, requests a decryption key corresponding to the content data which meet the disclosure condition of a decryption key management apparatus; and
a decryption key acquisition module which acquires the decryption key transmitted from the decryption key management apparatus in response to the request from the decryption key request module, wherein
the content data reproduction module, after the content data acquired by the content data acquisition module are decrypted with the decryption key acquired by the decryption key acquisition module, reproduces the content data.

14. The terminal apparatus according to claim 5, wherein
the content data acquisition module, even when it is not possible to acquire the content data corresponding to the acquisition request operation from the another terminal apparatus, acquires the content data corresponding to the acquisition request operation, when they meet their disclosure condition, from a content server apparatus holding the content data corresponding to the acquisition request operation.

15. A recording medium on which is recorded, in such a way as to be computer readable, a program for causing a computer to function as each module in the terminal apparatus according to claim 5.

16. An information processing method for use in a content distribution system which, including a plurality of terminal apparatus disposed dispersed in a network, carries out a transmission and reception of content data among the terminal apparatus, the method comprising:
a step of the terminal apparatus detecting a content data acquisition request operation by a user;
a step of the terminal apparatus, when the acquisition request operation is detected, acquiring the content data corresponding to the acquisition request operation from another terminal apparatus, via the network;
a step of the terminal apparatus storing the content data acquired;
a step of the terminal apparatus, when there has been a request from another terminal apparatus for a transmission of the content data stored, transmitting content data corresponding to the transmission request to the another terminal apparatus;
a step of the terminal apparatus acquiring disclosure condition information of the content data acquired;
a step of the terminal apparatus, based on the disclosure condition information acquired, determining whether or not the content data acquired meet a disclosure condition thereof; and
a step of the terminal apparatus carrying out a reproduction of content data determined to meet the disclosure condition.
